(19) United States
(12) Patent Application Publication
(10) Pub. No.: US 2013/0011611 A1
(43) Pub. Date: Jan. 10, 2013

(54) LAMINATE

(76) Inventors: Tokio Taguchi, Osaka-shi (JP); Takao Imaoku, Osaka-shi (JP); Kiyoshi Minoura, Osaka-shi (JP); Shigetaka Ikemoto, Iga-shi (JP); Kenji Hayakawa, Iga-shi (JP); Naoya Nishizaki, Iga-shi (JP); Yuhichi Yachiyama, Osaka-shi (JP)

(21) Appl. No.: 13/636,796

(22) PCT Filed: Mar. 4, 2011
(86) PCT No.: PCT/JP2011/055120

§ 371 Date: Sep. 24, 2012

(30) Foreign Application Priority Data
Mar. 24, 2010 (JP) 2010-068762

(51) Int. Cl. B32B 3/30

(52) U.S. Cl. 428/142

(57) ABSTRACT

The present invention provides a laminate including an anti-reflection film and a protective film that is stuck on the surface of the anti-reflection film. The protective film is excellent in temporary adhesiveness and can be removed to leave few adhesives. The laminate of the present invention directs to a laminate comprising an anti-reflection film; and a protective film stuck on the anti-reflection film, wherein the surface of the anti-reflection film has multiple protrusions, the distance between two tips of adjacent protrusions being equal to or smaller than visible light wavelength, and the protective film includes a support film and an adhesive layer that is in contact with the anti-reflection film, the adhesive layer including an adhesive that contains a polymer having an olefin structure as a monomer unit.

### TECHNICAL FIELD

The present invention relates to a laminate. More specifically, the present invention relates to a laminate including a moth-eye film to be stuck on a base to reduce surface reflection and a protective film suitable for protecting the surface of the moth-eye film.

### BACKGROUND ART

In recent years, protective films or protective sheets made of synthetic resins have been widely used for protecting various members. Particularly, films or sheets used for protecting members that are used outside need to have weather resistance and light resistance. Further, such films and sheets need to be removable depending on their intended use, and need to be firmly stuck and fixed on adherends for a while and easily removed from the adherends when the adherends are used.

Long-chain alkyl group-containing removers having an average degree of polymerization of 300 or less are known as adhesives excellent in removability. The removers include, as a composition, long-chain alkyl vinyl ester copolymers, long-chain alkyl amide copolymers, copolymers of long-chain alkyl derivatives of maleic acid, long-chain alkyl allyl ester copolymers, alkyl carbamates of various polymers, or mixtures of long-chain alkyl compound and various polymers (see, for example, Patent Literature 1).

The following compositions are known as a composition having good adhesiveness regardless of the polarity of an adherend, appropriate removability, and properties of not contaminating an adherend, and further suitable for applications where weather resistance and light resistance are required:

(1) an acrylic adhesive composition mainly including an acrylic copolymer prepared by copolymerization of an alkyl(meth)acrylate containing a C1-C14 alkyl group and a (meth)acrylate having a cyclic structure and a glass transition point Tg of 50° C. or higher; and

(2) an acrylic adhesive composition mainly including an acrylic copolymer prepared by copolymerization of an alkyl(meth)acrylate containing a C1-C14 alkyl group, a (meth)acrylate having a cyclic structure and a glass transition point Tg of 50° C. or higher, and a polymer that has a number average molecular weight of 2000 to 30000, and a glass transition point Tg of 30° C. or higher, with a terminal modified with a radical polymerizable unsaturated double bond (see, for example, Patent Literature 2).

In recent years, a moth-eye structure capable of providing an ultra-antireflection effect without using a conventional optical interference film has come to attention as technology capable of reducing surface reflection of a display device. Moth-eye structures are formed by arranging a pattern of protrusions and depressions having a size being equal to or smaller than visible light wavelength without any gap on the surface of a product to be anti-reflection treated. Such a pattern is finer than the pattern of protrusions and depressions formed using an anti-glare (AG) film. Such a moth-eye structure makes the change of the refractive index at the boundary between the outside (air) and the product surface pseudo-continuous. Thereby, almost all light passes through the film regardless of a refractive index interface so that light reflection from the product surface can be almost perfectly eliminated (see, for example, Patent Literatures 3 and 4).

### CITATION LIST

### Patent Literature

Patent Literature 1: JP7-48551 A
Patent Literature 2: JP2001-279208 A
Patent Literature 3: JP4368384 B
Patent Literature 4: JP4368415 B

### SUMMARY OF INVENTION

### Technical Problem

The present inventors have made various examinations of an anti-reflection film having multiple protrusions that are spaced with a nano-order distance or pitch (hereinafter, also referred to as moth-eye film). A moth-eye film transmits light because change of the refractive index of the interface between the film and air is spuriously eliminated. Therefore, the film is commonly stuck on the outermost surface of a product. The inventors has found that if the surface of the moth-eye film is exposed to the outside, the film may be contaminated and scratched due to external factors, and thereby antireflection characteristics of the film may deteriorate.

For this reason, the present inventors have made various examinations of a protective film used for protecting a moth-eye film from external factors to find out that a commonly used protective film is not suitable for a moth-eye film.

A protective film needs to be removed when a product is used, for example when a viewer watches display in the case that the product is a display device. However, when a conventional protective film is stuck on a moth-eye film for a predetermined time and removed, adhesive is left in gaps among protrusions of the moth-eye film (moth-eye film is contaminated) so that depressions are clogged, or the protective film is likely to be removed due to insufficient adhesion.

The present invention has been made in view of the above-described state of the art. The present invention has an object to provide a laminate including an anti-reflection film and a protective film that is stuck on the surface of the anti-reflection film. The protective film is excellent in temporary adhesiveness and can be removed to leave few adhesives.

### Solution to Problem

The present inventors specifically examined the reason why an adhesive is left on the surface of a moth-eye film, and they noted that, even if a protective film is stuck on a common low-reflection film having a flat surface (for example, LR (Low Reflection) film, AR (Anti Reflection) film) and a common anti-glare (AG) film having protrusions and depressions on the surface, with good adhesion, and removed without leaving adhesives, the protective film may be defectively adhered to a moth-eye film.

FIGS. 33 and 34 are each a schematic cross-sectional view of a moth-eye film and a conventional protective film stuck on the moth-eye film. FIG. 33 shows a state where a protective film is adhered. FIG. 34 shows a state where a protective film is removed. As shown in FIG. 33, the surface of a moth-eye film 112 includes multiple protrusions and a protective film 123 is stuck on the surface of the film 112. The protective film 123 includes a support film 121 and an adhesive layer 122 that is arranged on the film 121. The adhesive layer 122 is stuck on the surface with protrusions of the moth-eye film 112. However, part of the adhesive layer 122 flows into gaps among the protrusions of the moth-eye film 112 while the protective film 123 is stuck on the film 112. Therefore, as shown in FIG. 34, part of the adhesive is left among the protrusions after the protective film 123 is removed and no protrusions and depressions are apparently present, which results in a reduction in antireflection effect.

The present inventors have made intensive investigations in an attempt to develop a protective film suitable for a moth-eye film. They have found that common adhesives such as an acrylic adhesive and a rubber adhesive may be left on the surface of a moth-eye film, but an olefin adhesive is not left on the surface of a moth-eye film and provides sufficient adhesion. As a result, the present inventors admirably solved the problems, leading to completion of the present invention.

That is, the present invention directs to a laminate comprising: an anti-reflection film; and a protective film stuck on the anti-reflection film, wherein the surface of the anti-reflection film has multiple protrusions, the distance between two tips of adjacent protrusions being equal to or smaller than visible light wavelength, and the protective film includes a support film and an adhesive layer that is in contact with the anti-reflection film, the adhesive layer including an adhesive that contains a polymer containing an olefin structure as a monomer unit.

The configuration of the laminate of the present invention is not especially limited by other components as long as it essentially includes the above-mentioned components.

The laminate of the present invention includes an anti-reflection film and a protective film stuck on the anti-reflection film. The anti-reflection film stuck on a base reduces reflection on the base surface. For example, if the laminate of the present invention is stuck on a front board of a display device, the display device provides such fine display that less reflection of surroundings (e.g., a fluorescent lamp in the room) due to outdoor light reflection is generated.

Examples of a material of the base on which the laminate of the present invention is stuck include, but are not particularly limited to, glass, plastics, and metals. The base may be translucent or opaque. In the case that the base is opaque, a reflection prevention effect on the surface of the opaque base is achieved. For example, in the case of a black base, a jet black appearance is obtained, and in the case of a colored base, an appearance having a high purity of color is obtained. Thus, an aesthetically designed product is obtained. Examples of a product for which the laminate of the present invention is suitably used include components of display devices (a self-luminous display element, a non-self-luminous display device, a light source, a light diffusion sheet, a prism sheet, a polarized light reflection sheet, a retarder, a polarizer, a front board, and a case), lens, window glass, frame glass, show window, tanks, prints, pictures, coated products, and lighting apparatus.

The anti-reflection film has a surface with protrusions. The distance between tips of adjacent protrusions is equal to or smaller than visible light wavelength. As used herein, the phrase “equal to or smaller than visible light wavelength” means 380 nm which is a lower limit of a typical visible light wavelength band, or smaller. The distance is more preferably 300 nm or smaller and still more preferably 200 nm or smaller, which is approximately half the wavelength of visible light. If the distance between tips of protrusions exceeds 400 nm, a tint may be formed by a blue wavelength component. However, the effect of the tint can be sufficiently suppressed by setting the distance at or smaller than 300 nm and can be almost eliminated by setting the distance at or smaller than 200 nm.

The anti-reflection film may have other components such as a film base that supports the protrusions, as long as it has a surface with the protrusions and depressions. The film base may be formed of a material that is different from a material composing the protrusions, and may be translucent or opaque depending on its intended use. The anti-reflection film may have an adhesive layer that bonds a structure with the protrusions to a product. In this case, the adhesive layer is formed in the surface opposite to the surface with protrusions. The anti-reflection film may be directly formed on a base without using a film base, an adhesive layer, or the like.

The protective film includes a support film and an adhesive layer that is in contact with the anti-reflection film. The protective film is removable from an adherend (anti-reflection film) when a product is used. Further, the protective film is stuck with good adhesion and leaves no adhesive when removed. Therefore, features of the anti-reflection film do not deteriorate.

The adhesive layer includes an adhesive that contains a polymer having an olefin structure as a monomer unit. As used herein, a polymer (compound) including an aliphatic unsaturated hydrocarbon (olefin) structure that contains a double bond within a molecule as a monomer unit is also referred to as an “olefin compound”. Use of an adhesive including an olefin compound achieves good adhesion to a moth-eye film and provides an adhesive layer that can be removed to leave few adhesives.

Preferable embodiments of the laminate of the present invention are described in more detail below.

A contact angle of water on the surface of the anti-reflection film is preferably 10° or smaller. The anti-reflection film having a contact angle of 10° or smaller is a sufficiently hydrophilic one. Therefore, even if the surface of the anti-reflection film is contaminated, such contaminants can be easily wiped.

A contact angle of water on the surface of the adhesive layer is preferably 90° or larger. As described above, if the contact angle on the anti-reflection film is 10° or smaller, while contaminants on the film is favorably wiped off, a problem of adhesion of the adhesive layer and an adhesive residue after removal of the film may be arisen. However, according to the examination of the present inventors, adhesion and removability between an anti-reflection film and a protective film are also related to the polarities of the surface of the anti-reflection film and the surface of the adhesive layer. Accordingly, use of an adhesive (with water repellence) that provides a sufficiently large contact angle eliminates the problem of adhesion and an adhesive residue. Specifically, the contact angle of 90° or larger well solves the problems of adhesion and an adhesive residue.

A difference between a contact angle of water on the surface of the adhesive layer and a contact angle of water on the surface of the anti-reflection film is preferably 80° or larger. Such a difference of 80° or larger effectively allows the reduction of interaction between the adhesive layer and the adherend. Therefore, the problem of adhesion can be well solved and an adhesive residue is well prevented.

The proportion of a low molecular component in the adhesive is preferably 0.05 or less. Among adhesives having the same molecular weight, one having a higher proportion of low molecular components is likely to flow into gaps among protrusions to be left in the gaps. If the proportion of the low molecular components is reduced to the above mentioned proportion, contamination of the anti-reflection film due to the adhesive is less likely to be caused.

Storage elastic modulus of the adhesive at an ordinary temperature of 23° C. is preferably 0.05 MPa or more and 0.20 MPa or less. A viscoelastic body having a too high storage elastic modulus has low adhesion. On the other hand, a viscoelastic body having too low storage elastic modulus is likely to deform. If an adhesive layer needs to be removed, it needs a certain level of wettability (temporary adhesive strength) while the adhesive layer is stuck and appropriate removability, not permanent adhesive strength. In the above range, good adhesion strength achieving easy adhesion and easy removal can be obtained.

A glass transition temperature of the adhesive is preferably −5° C. or higher. The glass transition temperature (Tg) of −5° C. or higher prevents an adhesive from flowing into gaps among protrusions on the surface of the anti-reflection film.

### Advantageous Effects of Invention

According to the present invention, a laminate having, in its surface, a protective film that is excellent in temporary adhesion to a moth-eye film and that leaves few adhesives when removed can be obtained.

### BRIEF DESCRIPTION OF DRAWINGS

FIG. 1 is a schematic cross-sectional view of a laminate of Embodiment 1.

FIG. 2 shows the laminate of Embodiment 1 in which a protective film is removed from a moth-eye film.

FIG. 3 is a schematic cross-sectional view of the moth-eye film of Embodiment 1.

FIG. 4 is a schematic perspective view of the moth-eye film of Embodiment 1. Each protrusion has a conical shape.

FIG. 5 is a schematic perspective view of the moth-eye film of Embodiment 1. Each protrusion has a quadrangular pyramid shape.

FIG. 6 is a schematic perspective view of the moth-eye film of Embodiment 1. Each protrusion has such a shape that the inclination thereof is gradually reduced toward the tip from a bottom point.

FIG. 7 is a schematic perspective view of the moth-eye film of Embodiment 1. Each protrusion has such a shape that the inclination thereof is gradually reduced toward the tip from a bottom point.

FIG. 8 is a schematic perspective view of the moth-eye film of Embodiment 1. Each protrusion has such a shape that the inclination thereof is further increased in a region between the bottom point and the tip.

FIG. 9 is a schematic perspective view of the moth-eye film of Embodiment 1. Each protrusion has such a shape that the inclination thereof is gradually increased toward the tip from a bottom point.

FIG. 10 is a schematic perspective view of the moth-eye film of Embodiment 1. The levels of bottom points of adjacent protrusions are different from each other, and a col and a col point exist between adjacent protrusions.

FIG. 11 is a schematic perspective view of the moth-eye film of Embodiment 1. Adjacent protrusions are in contact at multiple points each other and a col and a col point exist between adjacent protrusions.

FIG. 12 is a schematic perspective view of the moth-eye film of Embodiment 1. Adjacent protrusions are in contact with each other at multiple points and a col and a col point exist between adjacent protrusions.

FIG. 13 is an enlarged schematic perspective view specifically showing protrusions of a moth-eye film. Each protrusion has a bell shape, and has a col and a col point.

FIG. 14 is an enlarged schematic perspective view specifically showing protrusions of a moth-eye film. Each protrusion has a needle-like shape, and has a col and a col point.

FIG. 15 is an enlarged schematic plan view of protrusions and depressions of a moth-eye structure.

FIG. 16 is a schematic view showing a cross section along the A-A′ line in FIG. 15 and a cross section along the B-B′ line in FIG. 15.

FIG. 17 is a schematic view showing the principle on which the moth-eye film of Embodiment 1 achieves low reflection, and showing a cross-sectional structure of the moth-eye film.

FIG. 18 is a schematic view showing the principle on which the moth-eye film of Embodiment 1 achieves low reflection, and showing a change in refractive index (effective refractive index) of light entering the moth-eye film.

FIG. 19 is a schematic cross-sectional view showing a protective film of Embodiment 1.

FIG. 20 is a schematic view of estimation of the percentage of contamination.

FIG. 21 is a graph showing increment ΔY of reflectance (Y value) and the percentage (%) of an amount of contamination of each molded resin, wherein a contact angle on the surface of an adhesive layer is defined as a variation value (horizontal axis).

FIG. 22 is a graph showing increment ΔY of reflectance (Y value) and the percentage (%) of an amount of contamination of each adhesive, wherein a contact angle on the surface of an adherend is defined as a variation value (horizontal axis).

FIG. 23 is a graph showing increment ΔY of reflectance (Y value) and the percentage (%) of an amount of contamination of each molded resin, wherein a difference (°) between a contact angle on the surface of an adhesive layer and a contact angle on the surface of an adhesive layer is defined as a variation value (horizontal axis).

FIG. 24 is a graph showing increment ΔY of reflectance (Y value) and the percentage (%) of an amount of contamination of each adhesive, wherein a difference (°) between a contact angle on the surface of an adhesive layer and a contact angle on the surface of an adhesive layer is defined as a variation value (horizontal axis).

FIG. 25 is a schematic cross-sectional view of an adherend of Reference Example 1.

FIG. 26 is a schematic cross-sectional view of an adherend of Reference Example 2.

FIG. 27 is a schematic cross-sectional view of an adherend of Reference Example 3.

FIG. 28 is a schematic cross-sectional view of an adherend of Reference Example 4.

FIG. 29 is a schematic cross-sectional view of an adherend of Example 3.

FIG. 30 is a graph showing temperature dependency of storage elastic moduli (Pa) of adhesives in Comparative Examples 1 to 6 and Examples 1 and 2.

FIG. 31 is a graph showing the relation between the glass transition point (° C.) and the adhesion strength N/25 mm of adhesives in Comparative Examples 1 to 6 and Examples 1 and 2.

FIG. 32 is a graph showing the relation between the contact angle (°) on the surface of an adhesive layer and reflectance (%) in Comparative Examples 1 to 6 and Examples 1 and 2.

FIG. 33 is a schematic cross-sectional view of a moth-eye film and a conventional protective film that is stuck on the moth-eye film.

FIG. 34 is a schematic cross-sectional view of a moth-eye film and a conventional protective film that is removed from the moth-eye film.

### DESCRIPTION OF EMBODIMENTS

The present invention will be described in more detail referring to the drawings in the following embodiments, but is not limited to these embodiments.

### Embodiment 1

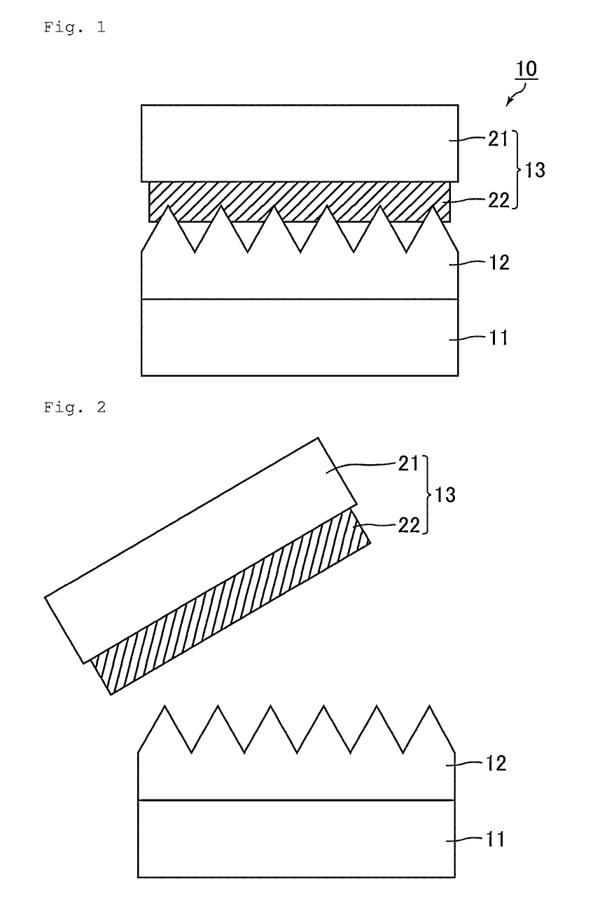

FIG. 1 is a schematic cross-sectional view of a laminate of Embodiment 1. As shown in FIG. 1, a laminate 10 of Embodiment 1 includes an anti-reflection film 12 and a protective film 13 that is stuck on the anti-reflection film 12. The laminate 10 of Embodiment 1 is stuck on a base 11, and thereby reflection on the surface of the base 11 can be reduced.

A moth-eye film is used as the anti-reflection film 12 of Embodiment 1. Most of light entering the surface of the moth-eye film 12 passes through the interface between air and the moth-eye film 12 and the interface between the moth-eye film 12 and the base 11. Therefore, the anti-reflection film 12 provides a better antireflection effect than that provided by a conventional anti-reflection film using light interference.

The laminate 10 of Embodiment 1 may be used for, for example, components of display devices (a self-luminous display element, a non-self-luminous display device, a light source, a light diffusion sheet, a prism sheet, a polarized light reflection sheet, a retarder, a polarizer, a front board, and a case), lens, window glass, frame glass, show window, tanks, prints, pictures, coated products, and lighting apparatus. Accordingly, the base 11 may be formed of any materials as long as the moth-eye film 12 can be disposed thereon. Examples of the material include glass, plastics, and metals. The base 11 may be translucent or opaque. In the case that the base is opaque, a reflection prevention effect on the surface of the opaque base is achieved. For example, in the case of a black base, a jet black appearance is obtained, and in the case of a colored base, an appearance having a high purity of color is obtained. Thus, an aesthetically designed product is obtained. The shape of the base 11 is not particularly limited. The base may be a melt-molded product such as a film, a sheet, an injection-molded product, and a press-molded product. Examples of the material of the base 11 when it is translucent include glass, plastics such as TAC (triacetyl cellulose), polyethylene, an ethylene/propylene copolymer, and PET (polyethylene terephthalate).

The protective film 13 is removed from the moth-eye film 12 when the laminate is used. Surfaces of visible parts on which moth-eye films are arranged can be provided with excellent low reflection characteristics. Thereby, reflection of surroundings due to outdoor light reflection is suppressed and good visibility can be obtained. However, the moth-eye film 12 tends to be scratched or contaminated by external factors, which may leads to quality deterioration of the moth-eye film 12. For this reason, in Embodiment 1, the laminate 10 in which the protective film 13 is stuck on the surface of the moth-eye film 12 is used for the outermost surface of a product, whereby the moth-eye film 12 is protected from the external factors.

In Embodiment 1, the surface of the moth-eye film 12 is partially exposed to outside after the protective film 13 is removed and such portions are likely to be contaminated. In order to easily eliminate such contamination, the moth-eye film preferably has a hydrophilic surface that is made by a material of a moth-eye film and an effect of an increase in surface area of fine structures of a moth-eye film. Specifically, the surface of the moth-eye film 12 preferably has a contact angle of water thereon of 10° or smaller. The contact angle differs depending on the material. In such a case, contamination can be easily wiped, and the moth-eye film 12 excellent in performance retention is obtained.

FIG. 2 shows the laminate of Embodiment 1 in which the protective film is removed from the moth-eye film. As shown in FIG. 2, the surface of the moth-eye film 12 is composed of multiple protrusions and the protective film 13 is stuck on the surface. The protective film 13 includes a support film 21 and an adhesive layer 22 disposed on the film 21. The adhesive layer 22 is stuck on the surface of the protrusions of the moth-eye film 12. According to the combination of the protective film 13 and the moth-eye film 12 of Embodiment 1, even if the protective film 22 is stuck on the moth-eye film 12 for a while and is removed from the film 12, no adhesive is left in gaps among the protrusions of the moth-eye film 12, as shown in FIG. 2. This prevents a reduction in antireflection effect due to clogging of depressions of the moth-eye film and keeps an excellent antireflection effect.

As described above, the protective film of Embodiment 1, which protects the surface and has excellent adhesion and resistance to contamination, is suitable for a moth-eye film.

The moth-eye film (anti-reflection film) of Embodiment 1 is described in detail below. FIG. 3 is a schematic cross-sectional view of the moth-eye film of Embodiment 1. As shown in FIG. 3, the anti-reflection film 12 of Embodiment 1 is disposed on the base 11 that is to be subjected to antireflection treatment.

As shown in FIG. 3, the moth-eye film 12 has a surface with multiple protrusions 12. The distance (the distance between adjacent protrusions in an aperiodic structure) or pitch (the distance between adjacent protrusions in a periodic structure) between tips of adjacent protrusions 12a is equal to or smaller than visible light wavelength. The moth-eye film 12 is composed of the protrusions 12a and a base portion 12b placed below (on the base 11 side of) the protrusions 12a.

The distance between tips of adjacent protrusions 12a is equal to or smaller than visible light wavelength. In other words, multiple protrusions 12a are arranged at a distance or a pitch of equal to or smaller than visible light wavelength on the surface of the moth-eye film 12. The protrusions 12a of Embodiment 1 are preferable in view of the advantage of causing no needless diffracted light when the protrusions have no regularity in their arrangement (aperiodic arrangement).

The base portion 12b includes a residual-resin film layer 12x that is generated during the formation of the protrusions 12a, a film base 12y for forming and holding the moth-eye structure, and an adhesive layer 12z that bonds the base portion 12b and the base 11. The residual-resin film layer 12x is a residual film that is left after the formation of the protrusions 12a, and is formed of the same material as the protrusions 12a.

The film base 12y is formed of a resin material. Examples of the resin material include triacetyl cellulose, polyethylene terephthalate, a polyolefin resin of a cyclic olefin polymer (represented by norbornene resins such as “Zeonor” (product name) (Zeon Corporation) and “Arton” (product name) (JSR Corporation)), polypropylene, polymethylpentene, a polycarbonate resin, polyethylene naphthalate, polyurethane, polyether ketone, polysulphone, polyether sulphone, polyester, a polystyrene resin, and an acrylic resin. A layer such as an anchor treatment layer and a hard coat layer may be formed on the surface of the base 12y so that the adhesion is improved.

The material of the adhesive layer 12z is not particularly limited. A separator film (for example, a PET film) may be stuck on the base 11-side surface of the adhesive layer 12z to protect the adhesive layer 12z.

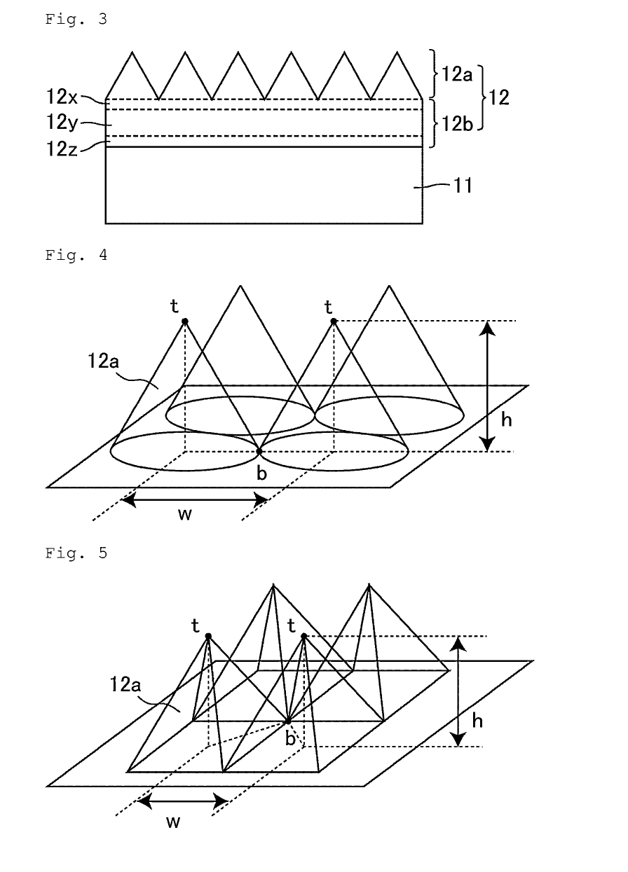

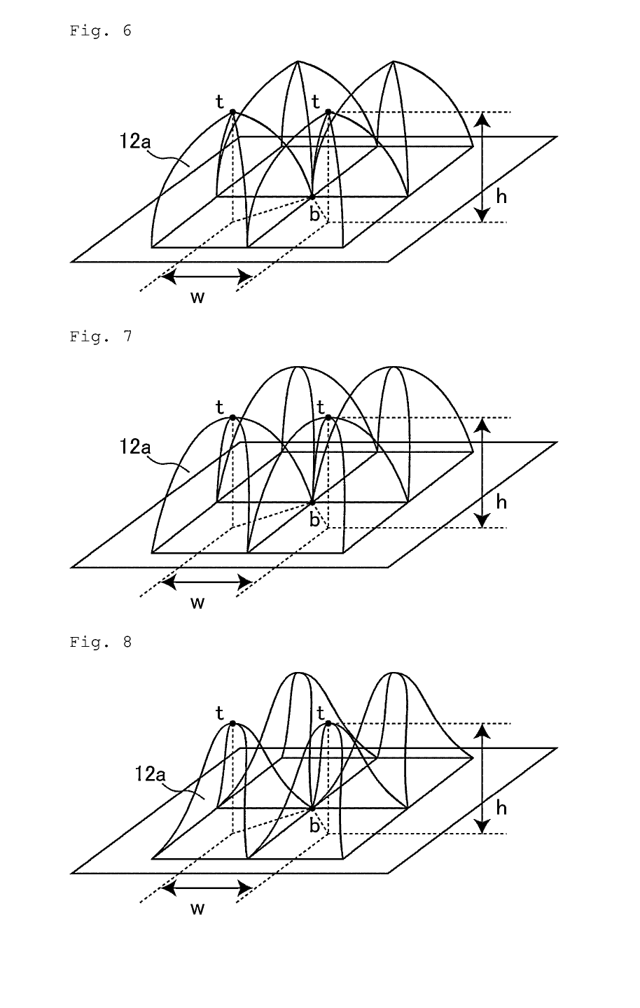

FIGS. 4 and 5 are each a schematic perspective view showing the moth-eye film of Embodiment 1. In FIG. 4, each protrusion has a conical shape. In FIG. 5, each protrusion has a quadrangular pyramid shape. As shown in FIGS. 4 and 5, the tip of the protrusion 12a is a tip t and a point at which the protrusions 12a are in contact with each other is a bottom point b. As shown in FIGS. 4 and 5, the distance w between tips of adjacent protrusions 12a is represented by the distance between two points which are the feet of the perpendicular lines drawn from the tips t of the protrusions 12a to the same plane. Further, the height h from the tip of the protrusion 12a to the bottom point is represented by the distance of the perpendicular line drawn from the tip t of the protrusion 12a to the plane including the bottom point b.

In the moth-eye film of Embodiment 1, the distance w between tips of adjacent protrusions is 380 nm or smaller, preferably 300 nm or smaller, and more preferably 200 nm or smaller. In FIGS. 4 and 5, conical shaped protrusions and square pyramid shaped protrusions are illustrated. In the surface of the moth-eye film of Embodiment 1, the structure of each protrusion is not particularly limited as long as a tip and a bottom point are formed and the distance or pitch between protrusions is controlled to be equal to or smaller than visible light wavelength. For example, each protrusion has such a shape that an inclination of a portion close to the tip of a protrusion is gentle (a hanging bell shape, a bell shape, or a dome shape) as shown in FIGS. 6 and 7, such a shape that an inclination of a region between a bottom point and a tip is steep (a sine shape) as shown in FIG. 8, such a shape that an inclination of a portion close to a tip of a protrusion is steep (a needle-like shape) as shown in FIG. 9, and a pyramidal shape having a step(s) at an inclined surface.

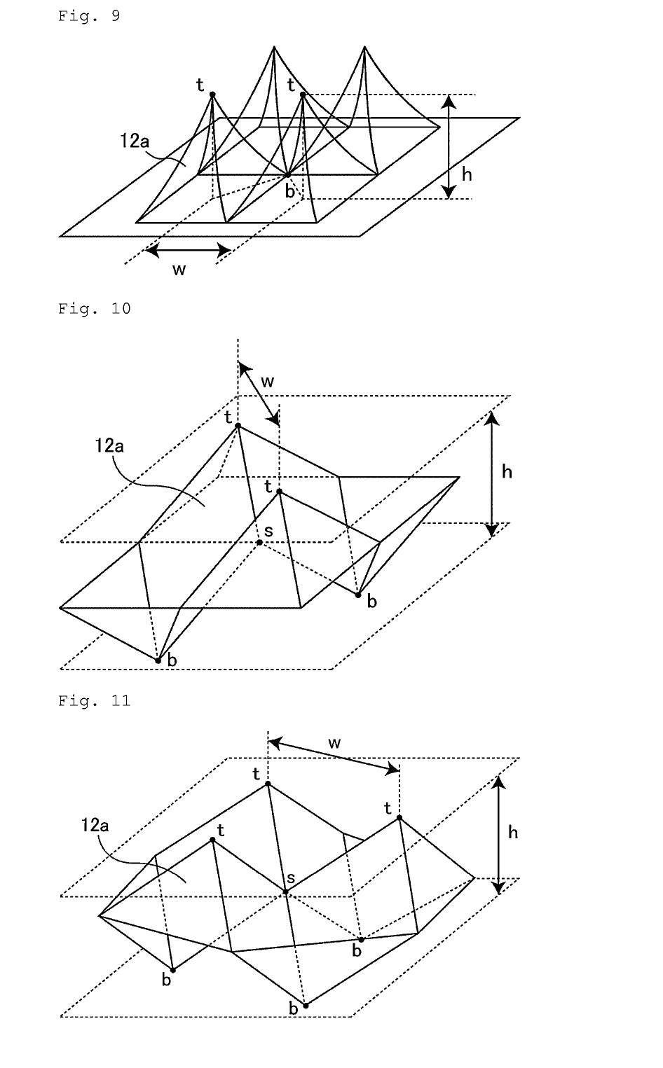

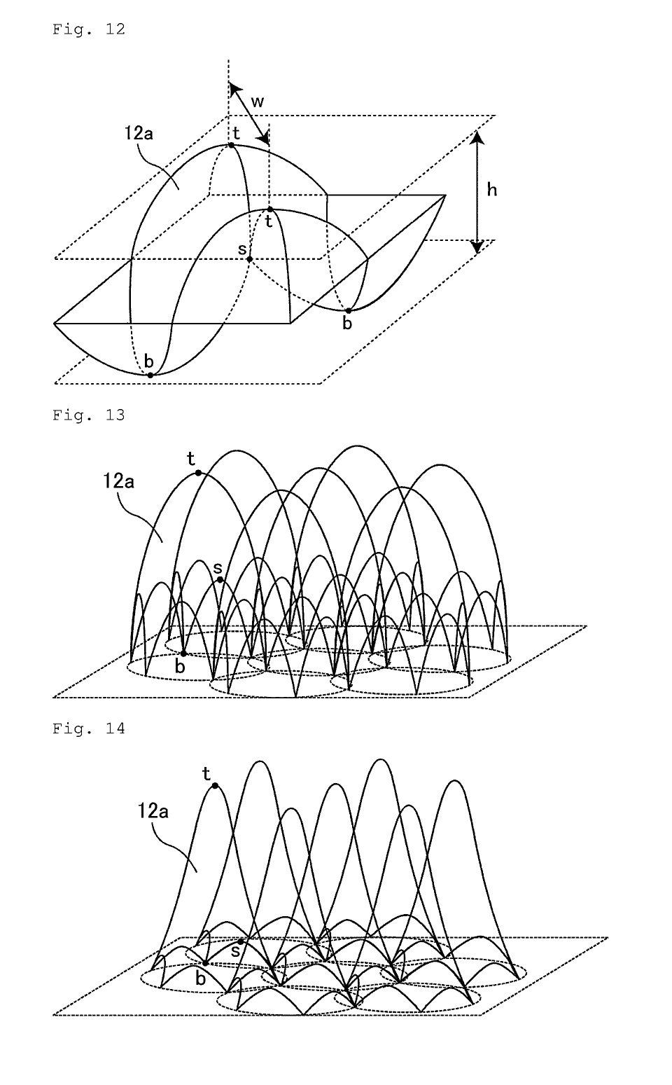

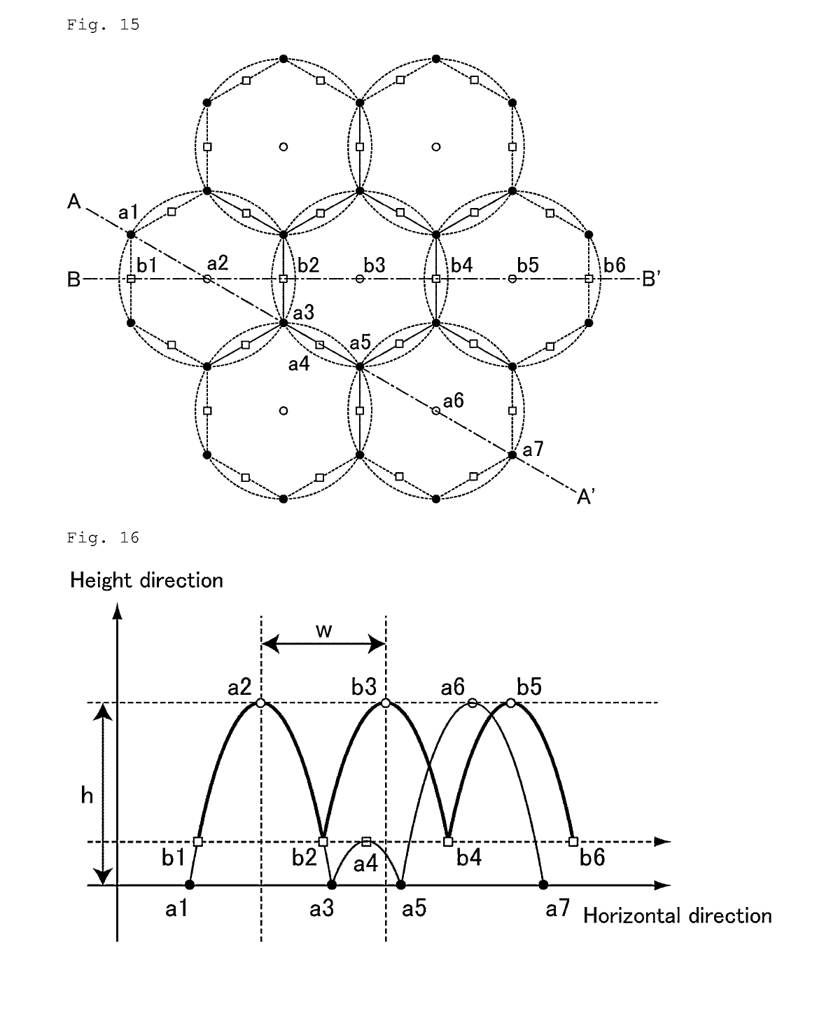

In Embodiment 1, the protrusions may be placed in various arrangements, or may not be arranged. In other words, adjacent bottom points, each of which is a contact point between the protrusions 12a, is not necessarily located on the same level. As shown in FIGS. 10 to 12, for example, the levels of the contact points of the protrusions 12a (contact points between the protrusions 12a) in the surface may be different from one another. In this case, such a structure includes a col. The col means a low point between two high places in a mountain range (“Kojien” the fifth edition). A protrusion having a single tip t has multiple contact points with adjacent protrusions and a col is formed at a position lower than the tip t. As used herein, the lowest contact point around a protrusion is referred to as a bottom point b and a point at a position lower than the tip t and higher than the bottom point b which serves as an equilibrium point of the col is referred to as a col point s. In this case, the distance w between tips of the protrusions 12a corresponds to the distance between adjacent tips and the height h corresponds to the distance between the tip and the bottom point in an orthogonal direction.

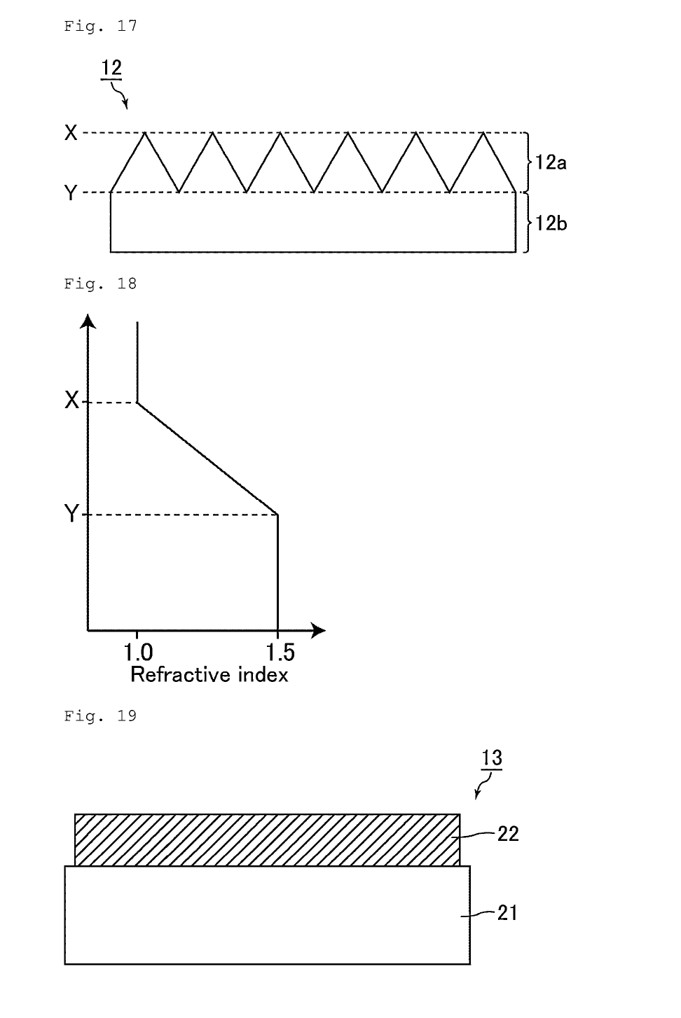

The present invention is described in more detail below. The following will show one example of the case in which a protrusion having a single tip has multiple contact points with adjacent protrusions, and a col (col point) is formed at a position lower than the tip t. FIGS. 13 and 14 are each an enlarged schematic perspective view specifically showing protrusions of the moth-eye film. In FIG. 13, each protrusion has a bell shape, and has a col and a col point. In FIG. 14, each protrusion has a needle-like shape, and has a col and a col point. As shown in FIGS. 13 and 14, the protrusion 12a having a single tip t has multiple contact points with adjacent protrusions and the contact points are formed at a position lower than the tip t. As used herein, the lowest point is referred to as a bottom point and a point at a position lower than the tip and higher than the bottom point is referred to as a col. A comparison of FIG. 13 with FIG. 14 shows that a col in a hanging bell shape is likely to be formed at a position higher than a col in a needle-like shape.

FIG. 15 is an enlarged schematic plan view of protrusions and depressions of a moth-eye structure. In FIG. 15, tips are indicated by white circles, bottom points are indicated by black circles, and col points of cols are indicated by white squares. As shown in FIG. 15, bottom points and col points are formed on a concentric circle centering on a single tip. FIG. 15 schematically shows six bottom points and six col points formed on a single circle. The present invention is not limited thereto and includes more irregular arrangements. White circles indicate tips, white squares indicate col points, and black circles indicate bottom points.

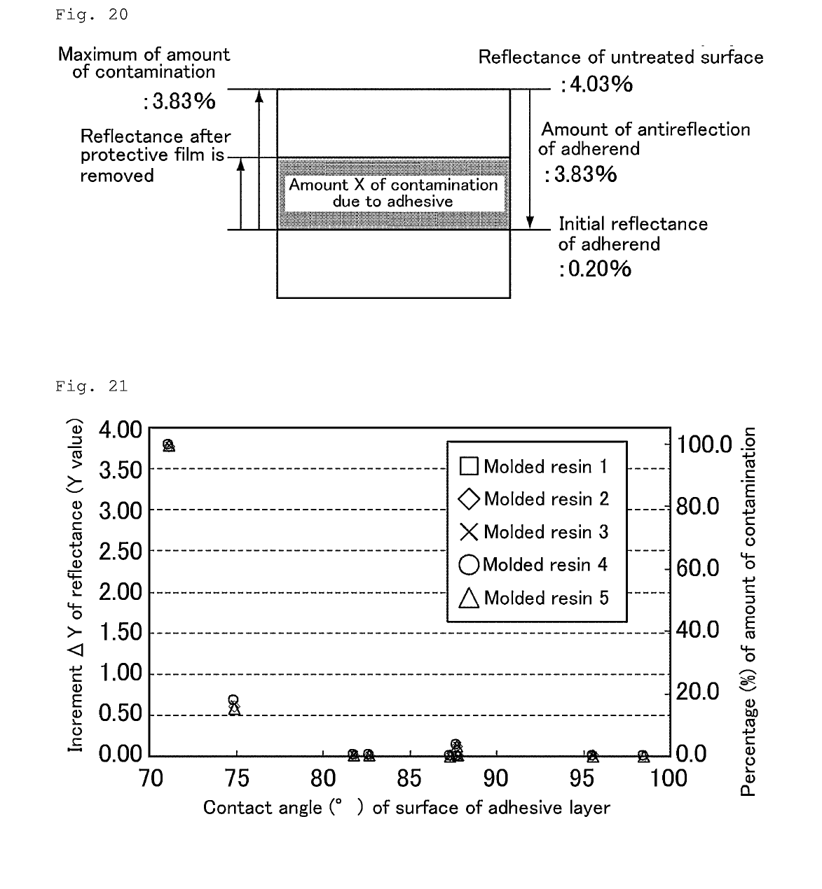

FIG. 16 is a schematic view showing a cross section along the A-A′ line in FIG. 15 and a cross section along the B-B′ line in FIG. 15. Tips are represented by a2, b3, a6, and b5, respectively, cols are represented by b1, b2, a4, b4, and b6, respectively, and bottom points are represented by a1, a3, a5, and a7, respectively. In this case, a2 and b3 are adjacent to each other and b3 and b5 are adjacent to each other, and the distance between a2 and b3 and the distance between b3 and b5 each correspond to the distance w between adjacent tips. Further, the difference between the height of a2 and the height of a1, the difference between the height of a2 and the height of a3, the difference between the height of a6 and the height of a5, and the difference between the height of a6 and the height of a7 each correspond to the height h of the protrusion.

The following will describe the principle on which the moth-eye film of Embodiment 1 achieves low reflection. FIGS. 17 and 18 are each a schematic view showing the principle on which the moth-eye film of Embodiment 1 achieves low reflection. FIG. 17 shows a cross-sectional structure of the moth-eye film and FIG. 18 shows a change in refractive index (effective refractive index) of light entering the moth-eye film. As shown in FIGS. 17 and 18, the moth-eye film 12 of Embodiment 1 includes the protrusions 12a and the base portion 12b. When travelling from one medium to another medium, light is refracted, transmitted, and reflected at the interface between these media. The degrees of refraction and the like depend on the refractive index of the medium through which light passes. For example, the air has a refractive index of about 1.0 and a resin has a refractive index of about 1.5. In Embodiment 1, each of the protrusions formed on the surface of the moth-eye film 12 has a substantially conical shape, in other words, a shape gradually tapered toward the tip direction. Accordingly, FIGS. 17 and 18 show that the refractive index gradually and continuously increases from about 1.0, which is the refractive index of air, to the refractive index of the film constituent (about 1.5 in the case of resin) in the protrusion 12a (X-Y) at the interface between the air layer and the moth-eye film 12. The amount of reflected light depends on the difference between the refractive indexes of the media. Therefore, pseudo elimination of the almost entire refractive interface of light allows most part of the light to pass through the moth-eye film 12. Thereby, the reflectance on the film surface remarkably reduces. FIG. 17 shows the protrusions and depressions each having a substantially conical shape as one example. However, the shape is not limited thereto as long as the protrusions and depressions exert an antireflection effect of the moth-eye film based on the above principle.

One example of a suitable profile of the protrusions constituting the surface of the moth-eye film 12 is 50 nm to 200 nm in distance between adjacent protrusions and 50 nm to 400 nm in height of each protrusion. FIGS. 1 to 18 show a case that the multiple protrusions 12a are arranged so as to have a repeating unit with a period of equal to or smaller than visible light wavelength as a whole. However, the protrusions may have a portion without periodicity, or may have no periodicity as a whole. Further, distances between a single arbitrary protrusion of the multiple protrusions and the multiple adjacent protrusions may differ from each other. An aperiodic structure leads to an advantage in performance that transmission due to regular arrangement and diffraction scattering of reflection are less likely to be occurred, and an advantage in production that the pattern is easily produced. Further, as shown in FIGS. 10 to 16, the moth-eye film 12 may be formed with multiple bottom points positioned in different levels on the periphery of a single protrusion. The surface of the moth-eye film 12 may also include micro order protrusions and depressions or larger that are larger than nano-order protrusions and depressions, that is, a duplex structure of protrusions and depressions.

The method of forming the moth-eye film 12 is described below. First, a glass substrate is prepared, and aluminum (Al) as a material of a mold is deposited on the glass substrate by sputtering to form an aluminum film. Next, the aluminum film is anodized, and then immediately etched. These steps are repeated to form an anodized layer with a large number of fine holes (depressions). The distance between the bottom points of adjacent fine holes is equal to or smaller than visible light wavelength. Specifically, anodic oxidation, etching, anodic oxidation, etching, anodic oxidation, etching, anodic oxidation, etching, and anodic oxidation (anodic oxidation: 5 times, etching: 4 times) are performed in the stated order to prepare a mold. Repeating of the anodic oxidation and the etching provides fine holes with a shape tapered toward the inside of the mold. The substrate of the mold is not limited to glass, and examples thereof include metal materials such as SUS and Ni, and resin materials such as polypropylene, polymethylpentene, a polyolefin resin of a cyclic olefin polymer (represented by norbornene resin such as “Zeonor” (product name) (ZEON CORPORATION) and “Arton” (product name) (JSR Corporation)), a polycarbonate resin, polyethylene terephthalate, polyethylene naphthalate, and triacetyl cellulose. Further, an aluminum bulk substrate may be used instead of an aluminum-coated substrate. The shape of the mold may be a flat plate or a roll (cylindrical shape).

A method for manufacturing the mold is described. First, a 10-cm square glass substrate is prepared, and a 1.0-μm thick aluminum (Al) film as a material of a mold is formed on the glass substrate by sputtering. The thickness of the aluminum (Al) film as a material of the mold is 1.0 μm. The anodic oxidation is performed under the conditions of oxalic acid of 0.6 wt %, a liquid temperature of 5° C., and an applied voltage of 80 V. Adjustment of the anodic oxidation time causes a difference in size (depth) of each hole to be formed. Table 1 shows the relation between the anodic oxidation time and the size (depth) of the hole. The etching is performed for 25 minutes under the conditions of phosphoric acid of 1 mol/l and a liquid temperature of 30° C. in every example.

TABLE 1

| | Anodic | Depth of | | | |
|---|---|---|---|---|---|
| | oxidation | depression | Height of | Transfer | Aspect |
| | time (sec) | (nm) | protrusion (nm) | ratio | ratio |
| Mold 1 | 15 | 231 | 143 | 0.62 | 0.72 |
| Mold 2 | 20 | 328 | 175 | 0.53 | 0.88 |
| Mold 3 | 24 | 387 | 219 | 0.57 | 1.10 |
| Mold 4 | 33 | 520 | 255 | 0.49 | 1.28 |
| Mold 5 | 38 | 600 | 373 | 0.62 | 1.87 |

A translucent 2P (photo-polymerizable) resin solution is dropped on the surface of each mold prepared through the above production process and a base (for example, TAC film) is carefully stuck on a 2P resin layer made of the 2P resin solution so as not to generate air bubbles. Next, the 2P resin layer is irradiated with ultraviolet (UV) light at 2 J/cm² to be hardened. The resulting 2P resin film and the TAC film are taken out. Specific examples of a method of forming (duplicating) fine protrusions and depressions on the base using a mold include, in addition to the 2P method (photo-polymerization method), duplicating methods such as a heat pressing method (embossing method), injection molding method, and sol-gel method, a method of laminating a shaped sheet with fine protrusions and depressions, and a method of printing a layer with fine protrusions and depressions. The method may be appropriately selected therefrom depending on the uses of anti-reflection products and the materials of the bases.

A surface with fine protrusions and depressions has a large area, whereby if the surface is formed of a hydrophobic (water-repellent) material, an ultra water-repellent property is provided (due to the lotus effect) and if the surface is formed of a hydrophilic material, an ultra-hydrophilic property is provided. Therefore, a moth-eye structure with surfaces different in condition, such as a hydrophilic surface and a hydrophobic (water repellent) surface, may be formed depending on the kind of the materials of the protrusions and depressions and the shapes of the protrusions and depressions. If the surface of the moth-eye structure is hydrophilic, contaminants on the surface can be wiped out with a damp cloth, whereby the performance of the moth-eye structure is sufficiently exhibited. On the other hand, if the surface of the moth-eye structure is hydrophobic (water repellent), water scale is less likely to be deposited, whereby an antifouling property is sufficiently exhibited. In view of contamination due to an adhesive of the protective film, the hydrophilic surface of the moth-eye film structures is remarkably contaminated. Therefore, the protective film of the present invention is suitable for a hydrophilic moth-eye structure, but may be used for a hydrophobic (water repellent) moth-eye structure.

The depth of the depression of the mold and the height of the protrusion of the moth-eye film may be determined using SEM (scanning electron microscope). The contact angle of water on the surface of the moth-eye structure may be determined using a contact angle meter.

Examples of a material of the protrusions and the depressions of the moth-eye film (moth-eye structure) include the above described photo-curable resin composition, an active energy ray-curable resin composition such as an electron-beam curable resin composition, and a thermosetting resin composition.

A monomer and/or an oligomer polymerizable by an active energy ray may be an organic one or an inorganic one, and are polymerized to become a polymer by exposure to active energy rays such as ultraviolet rays, visible energy rays, and infrared rays, in the presence or absence of a photopolymerization initiator. They may be radically polymerized, anionically polymerized, or cationically polymerized. The monomer and/or the oligomer, for example, contains a group such as a vinyl group, a vinylidene group, an acryloyl group, and a methacryloyl group (hereinafter, an acryloyl group and a methacryloyl group are also referred to as (meth)acryloyl groups. The same shall apply to (meth)acryl and (meth)acrylates). Particularly, a (meth)acryloyl group-containing monomer and/or oligomer is preferable because they are rapidly polymerized by active energy ray irradiation. The active energy ray curable resin composition may include a non-reactive polymer or an active energy ray sol/gel reactive composition.

Examples of a method of forming a hydrophilic surface of a molded product include physical surface treatment such as corona treatment, plasma treatment, and ultraviolet treatment; chemical surface treatment such as sulfonation; kneading of a surfactant or a hydrophilic substance; use of a hydrophilic group-containing polymer as a molding material; and coating with a hydrophilic polymer. Graft polymerization of a hydrophilic monomer on the surface of a polymer molded product is known. Examples of the active energy ray curable composition which can be formed into a hydrophilic film include an ultraviolet curable composition including polyalkylene glycol(meth)acrylate and a reactive surfactant that contains an alkylene oxide bond within the molecule, an ultraviolet curable composition including polyfunctional acrylate and a reactive surfactant that contains two or more hydroxyl groups within the molecule and an alkylene oxide bond within the molecule, an energy ray curable composition including an amphiphilic polymerizable compound that contains a polyethylene glycol chain with repeating units of 6 to 20 ethylene glycols, a photo curable composition including polyurethane(meth)acrylate, diacrylate containing a cyclic structure, and polyalkylene glycol acrylate.

Examples of a monomer polymerizable by an active energy ray include monofunctional monomers such as ethyl(meth)acrylate, n-butyl(meth)acrylate, isobutyl(meth)acrylate, t-butyl(meth)acrylate, hexyl(meth)acrylate, 2-ethylhexyl(meth)acrylate, lauryl(meth)acrylate, stearyl(meth)acrylate, phenyl(meth)acrylate, phenyl cellosolve(meth)acrylate, nonylphenoxy polyethylene glycol(meth)acrylate, isobornyl(meth)acrylate, dicyclopentanyl(meth)acrylate, and dicyclopentenyloxyethyl(meth)acrylate;

bifunctional monomers such as 1,6-hexanediol di(meth)acrylate, polypropylene glycol di(meth)acrylate, hydroxypivalic acid neopentyl glycol di(meth)acrylate, neopentyl glycol di(meth)acrylate, 3-acryloyloxyglycerine monomethacrylate, 2,2′-bis(4-(meth)acryloyloxy polyethyleneoxyphenyl)propane, 2,2′-bis(4-(meth)acryloyloxy polypropyleneoxy phenyl)propane, dicyclopentanyl di(meth)acrylate, bis[(meth)acryloyloxy ethyl]hydroxyethyl isocyanate, phenyl glycidyl ether acrylate tolylene diisocyanate, and adipic acid divinyl;

trifunctional monomers such as trimethylolpropane tri(meth)acrylate, trimethylolethane tri(meth)acrylate, tris[(meth)acryloyloxy ethyl] isocyanate, pentaerythritol tri(meth)acrylate;

tetrafunctional monomers such as pentaerythritol tetra(meth)acrylate and glycerine di(meth)acrylate hexamethylene diisocyanate;

pentafunctional monomers such as dipentaerythritol monohydroxypenta(meth)acrylate; and

hexafunctional monomers such as dipentaerythritol hexa(meth)acrylate.

The oligomer polymerizable by an active energy ray contains a polymerizable functional group that is polymerizable by an active energy ray, and preferably has a molecular weight of 500 to 50000. Examples of the oligomer include (meth)acrylates of an epoxy resin, such as a bisphenol A-diepoxy-(meth)acrylic acid adduct, a (meth)acrylate of a polyether resin, a (meth)acrylate of a polybutadiene resin, a polyurethane resin having a (meth)acrylic group at a molecular terminal.

The monomers and/or the oligomers polymerizable by an active energy ray may be used singly or two or more of these may be mixed. For example, two or more of the monomers may be mixed, two or more of the oligomers may be mixed, or one or two or more of the monomers and one or two or more of the oligomers may be mixed.

The crosslink density of the moth-eye structure of a molded product with a hydrophilic surface (that is, a cured product of a molded product including the monomer and/or the oligomer polymerizable by an active energy ray) may be arbitrarily controlled depending on the kind of the monomer and/or the oligomer polymerizable by an active energy ray.

Use of a hydrophobic (water repellent) monomer and/or oligomer polymerizable by an active energy ray may provide moth-eye structure with a hydrophobic (water repellent) surface.

The photopolymerization initiator is not particularly limited as long as it is active to an active energy ray used in the present embodiment and polymerizes a monomer and/or oligomer and a hydrophilic monomer and/or a hydrophilic oligomer. A radical polymerization initiator, an anionic initiator, and a cationic initiator may be used. Examples of the photopolymerization initiator include acetophenones such as p-tert-butyltrichloroacetophenone, 2,2′-diethoxyacetophenone, and 2-hydroxy-2-methyl-1-phenylpropane-1-one; ketones such as benzophenone, 4,4′-bis-dimethylaminobenzophenone, 2-chlorothioxanthone, 2-methylthioxanthone, 2-ethylthioxanthone, and 2-isopropylthioxanthone; benzoin ethers such as benzoin, benzoin methyl ether, benzoin isopropyl ether, and benzoin isobutyl ether; and benzyl ketals such as benzyl dimethyl ketal and hydroxycyclohexyl phenyl ketone.

A hydrophilic monomer and/or a hydrophilic oligomer include(s) at least one hydrophilic group within the molecule. Examples of the hydrophilic group include: nonionic hydrophilic groups such as a polyethylene glycol group, a polyoxymethylene group, a hydroxyl group, a sugar-containing group, an amide group, and a pyrolidone group; anionic hydrophilic groups such as a carboxyl group, a sulfone group, and a phosphate group; cationic hydrophilic groups such as an amino group and an ammonium group; and dipolar ion groups such as an amino acid-containing group and a phosphate group/an ammonium ion group. The hydrophilic monomer and/or the hydrophilic oligomer may include derivatives of these hydrophilic groups. Examples of the derivatives include N-substituted products of an amino group, an amide group, an ammonium group, and a pyrolidone group. Each of the hydrophilic monomer and/or the hydrophilic oligomer may have one hydrophilic group or two or more of these, or may have two or more kinds of hydrophilic groups, within the molecule.

Examples of the hydrophilic monomer and/or the hydrophilic oligomer include: a hydroxyl group-containing monomer such as 2-hydroxyethyl(meth)acrylate, 2-hydroxypropyl(meth)acrylate, and glycerol mono(meth)acrylate; a polyethylene glycol structural unit-containing monomer such as diethylene glycol mono(meth)acrylate, triethylene glycol mono(meth)acrylate, tetraethylene glycol mono(meth)acrylate, nonaethylene glycol mono(meth)acrylate, tetradecaethylene glycol mono(meth)acrylate, trieicosaethylene glycol mono(meth)acrylate, polyethylene glycol mono(meth)acrylate, methoxy diethylene glycol(meth)acrylate, methoxy triethylene glycol(meth)acrylate, methoxy tetraethylene glycol(meth)acrylate, methoxy nonaethylene glycol(meth)acrylate, methoxy tetradecaethylene glycol(meth)acrylate, methoxy trieicosaethylene glycol(meth)acrylate, methoxy polyethylene glycol(meth)acrylate, phenoxy diethylene glycol(meth)acrylate, phenoxy tetraethylene glycol(meth)acrylate, phenoxy hexaethylene glycol(meth)acrylate, phenoxy nonaethylene glycol(meth)acrylate, and phenoxy polyethylene glycol(meth)acrylate;

amide group-containing monomers such as N-ethyl(meth)acrylamide, N-n-propyl(meth)acrylamide, N-isopropyl(meth)acrylamide, N-cyclopropyl(meth)acrylamide, N-methyl-N-ethyl(meth)acrylamide, N,N-dimethyl(meth)acrylamide, N,N-diethyl(meth)acrylamide, N-methyl-N-isopropyl(meth)acrylamide, N-methyl-N-n-propyl(meth)acrylamide, N-(meth)acryloyl morpholine, N-(meth)acryloylpyrrolidine, N-(meth)acryloylpiperidine, N-vinyl-2-pyrolidone, N-methylenebisacrylamide, N-methoxypropyl(meth)acrylamide, N-isopropoxypropyl(meth)acrylamide, N-ethoxypropyl(meth)acrylamide, N-1-methoxymethyl propyl(meth)acrylamide, N-methoxyethoxy propyl(meth)acrylamide, N-1-methyl-2-methoxyethyl(meth)acrylamide, N-methyl-N-n-propyl(meth)acrylamide, and N-(1,3-dioxolane-2-yl)(meth)acrylamide;

amino group-containing monomers such as N,N-dimethylaminoethyl(meth)acrylate, N,N-dimethylaminopropyl(meth)acrylamide, N,N-(bis methoxymethyl)carbamyloxyethyl methacrylate, and N-methoxymethyl carbamyloxyethyl methacrylate; carboxyl group-containing monomers such as 2-(meth)acryloyloxyethyl phthalic acid, 2-(meth)acryloyloxypropyl phthalic acid, and 2-(meth)acryloyloxyethyl succinic acid;

phosphate group-containing monomers such as mono(2-methacryloyloxyethyl)acid phosphate and mono(2-acryloyloxyethyl)acid phosphate;

quaternary ammonium base-containing monomers such as (meth)acryloyloxyethyl trimethylammonium chloride and (meth)acryloyloxypropyl trimethylammonium chloride;

sulfone group-containing monomers such as 2-acrylamide-2-methylpropane sulfonic acid, 2-acrylamide-2-phenylpropane sulfonic acid, sodium(meth)acryloyloxyethylsulfonate, ammonium(meth)acryloyloxyethylsulfonate, allylsulfonic acid, methallylsulfonic acid, vinylsulfonic acid, styrenesulfonic acid, and sulfonic acid sodium salt ethoxy methacrylate; and

polymerizable oligomers with a molecular weight of 500 to 50000 having such a hydrophilic group. A (meth)acrylic monomer and/or a (meth)acrylic oligomer containing an amino acid skeleton within the molecule may be used as a hydrophilic monomer and/or a hydrophilic oligomer. Further, a (meth)acrylic monomer and/or a (meth)acrylic oligomer containing a sugar skeleton within the molecule may be used as a hydrophilic monomer and/or a hydrophilic oligomer.

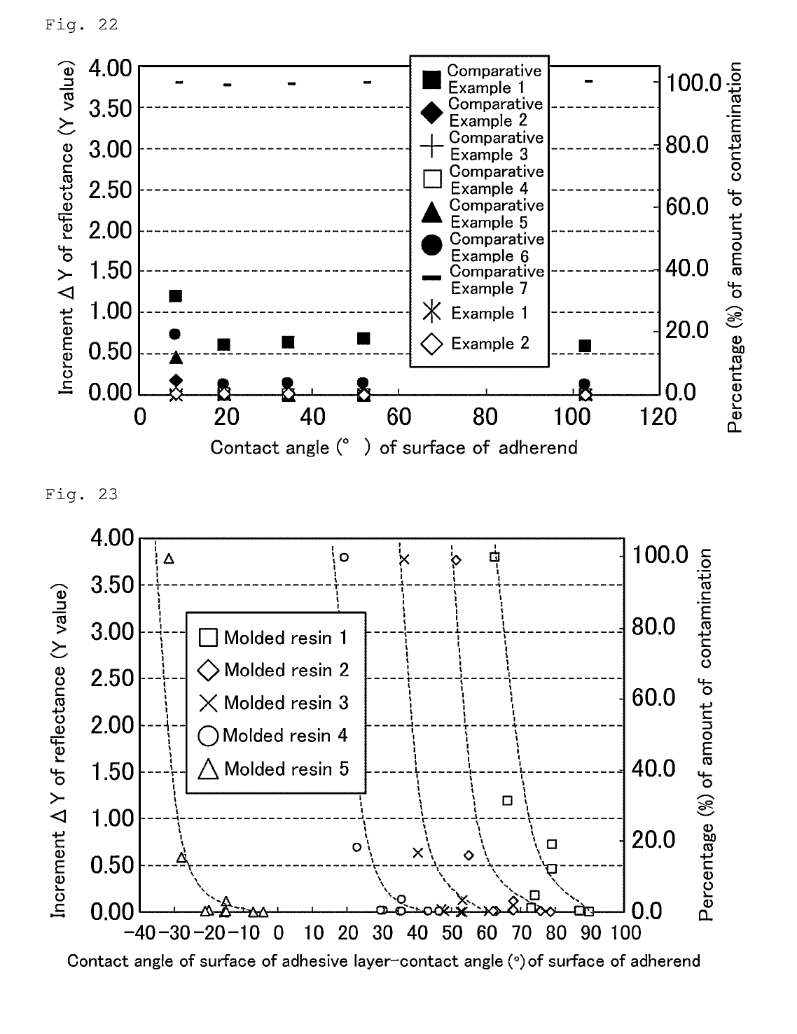

The protective film of Embodiment 1 is described below. FIG. 19 is a schematic cross-sectional view showing the protective film of Embodiment 1. As shown in FIG. 19, a protective film 13 of Embodiment 1 includes a support film 21 and an adhesive layer 22. Examples of a type and a material of the support film 21 include, but are not particularly limited to, resins such as PET (polyethylene terephthalate). An adhesive forming the adhesive layer 22 may not be a single compound, and may be mixed with an additive. An anchoring agent may be applied between the support film 21 and the adhesive layer 22 in order to improve the adhesion. The surface of the support film 21 may be pre-treated (for example, corona treatment, plasma treatment) in order to improve the adhesion with the adhesive layer 22.

The adhesive of Embodiment 1 includes an olefin compound (a polymer having an olefin structure as a monomer unit). Specific examples of the olefin compound include polyethylene, polypropylene, an ethylene-propylene random copolymer, an ethylene-propylene block copolymer, polybutene-1, an ethylene-polybutene-1 copolymer, an ethylene-butene-1 copolymer, poly-4-methylpentene-1, a poly-4-methylpentene-1 copolymer, an ethylene-vinylacetate copolymer, an ethylene-methacrylate copolymer, an ethylene-methyl methacrylate polymer, an ethylene-butyl methacrylate polymer, an ethylene-vinylalcohol copolymer, an ethylene-vinylalcohol copolymer-vinylacetate copolymer, an ethylene-acrylonitrile copolymer, an ethylene-methacrylic acid-acrylonitrile copolymer, an ethylene-styrene copolymer, polypentene-1, polyhexene-1, poly-4-methyl-pentene-1, ethylene-propylene rubber, ethylene-propylene-nonconjugated diene copolymerized rubber, an ethylene-1-octene copolymer, an ethylene-methyl acrylate copolymer, and an ethylene-ethyl acrylate copolymer.

Examination results of the protective film suitable for the moth-eye film are explained below.

For the examinations, the protective films in Examples 1 and 2 are prepared as a sample of the present invention, and the protective films in Comparative Examples 1 to 7 are prepared as comparative samples of the present invention. Table 2 shows materials of and presence and absence of an adhesive, an additive, an anchoring agent, a mold lubricant, and a support film of the protective films of Comparative Examples 1 to 7 and Examples 1 and 2.

TABLE 2

| | | | | Anchoring | Mold | Material of |
|---|---|---|---|---|---|---|
| | Adhesive | | Additive | agent | lubricant | support film |
| Comparative | General acrylic | Acrylic ester | Modified isocyanate | Absence | Absence | Polyethylene |
| Example 1 | | copolymer resin | | | | |
| Comparative | General acrylic | Acrylic ester | Dibutyl phosphate | Absence | Absence | Polyethylene |
| Example 2 | | copolymer resin | Monobutyl phosphate | | | |
| Comparative | General acrylic | Acrylic ester | Modified isocyanate | Absence | Absence | Polyethylene |
| Example 3 | | copolymer resin | | | | |
| Comparative | Special acrylic | Acrylic ester | Modified isocyanate | Absence | Absence | Polyethylene |
| Example 4 | | copolymer resin | | | | |
| Comparative | General rubber | Hydrogenated | Hydrogenated | Absence | Long chain | Ethylene- |
| Example 5 | | styrene-butadiene | petroleum resin | | alkyl acrylate | propylene |
| | | copolymer | Rosin resin | | polymer | copolymer |
| | | | Modified isocyanate | | | |
| Comparative | General rubber | Hydrogenated | Hydrogenated | Absence | Long chain | Ethylene- |
| Example 6 | | styrene-butadiene | petroleum resin | | alkyl acrylate | propylene |
| | | copolymer | Rosin resin | | polymer | copolymer |
| | | | Modified isocyanate | | | |
| Comparative | Urethan | Polyurethan resin | Absence | Absence | Absence | Ethylene- |
| Example 7 | | | | | | propylene |
| | | | | | | copolymer |
| Example 1 | Olefin | Modified | Modified isocyanate | Modified | Absence | Polyethylene |
| | | polypropylene | | polyolefin | | terephthalate |
| | | polymer | | | | |
| Example 2 | Heat resistance- | Modified | Modified isocyanate | Absence | Absence | Polyethylene |
| | improving olefin | polypropylene | | | | terephthalate |
| | | polymer | | | | |

A general acrylic material, a special acrylic material, a general rubber material, an urethane material, an olefin material, or a heat resistance-improving olefin material is used as the adhesive. The olefin material or the heat resistance-improving olefin material is used in Examples and the other materials are used in Comparative Examples.

In Comparative Example 1, an acrylate copolymer resin that is a general acrylic material was used as an adhesive and mixed with modified isocyanate as an additive. Polyethylene was used as a material of the support film on which the adhesive layer was arranged.

In Comparative Example 2, an acrylate copolymer resin that is a general acrylic material was used as an adhesive, and mixed with dibutyl phosphate and monobutyl phosphate as additives. Polyethylene was used as a material of a support film on which an adhesive layer was arranged.

In Comparative Example 3, an acrylate copolymer resin that is a general acrylic material was used as an adhesive and mixed with modified isocyanate as an additive. Polyethylene was used as a material of the support film on which the adhesive layer was arranged.

In Comparative Example 4, an acrylate copolymer resin that is a special acrylic material was used as an adhesive and mixed with modified isocyanate as an additive. Polyethylene was used as a material of the support film on which the adhesive layer was arranged.

In Comparative Example 5, a hydrogenated styrene-butadiene copolymer resin that is a general rubber material was used as an adhesive and mixed with a hydrogenated petroleum resin, a rosin resin, and modified isocyanate as additives. A long chain alkyl acrylate polymer was applied on the support film as a mold lubricant. An ethylene-propylene copolymer was used as a material of the support film on which the adhesive layer was arranged.

In Comparative Example 6, a hydrogenated styrene-butadiene copolymer resin that is a general rubber material was used as an adhesive and mixed with a hydrogenated petroleum resin, a rosin resin, and modified isocyanate as additives. A long chain alkyl acrylate polymer was applied on the support film as a mold lubricant. The unwinding force of a tape with a rubber tends to be strong, but can be reduced by application of the mold lubricant. An ethylene-propylene copolymer was used as a material of the support film on which the adhesive layer was arranged. The surface of the adhesive layer of Comparative Example 6 was embossed with protrusions and depressions.

In Comparative Example 7, a polyurethane resin that is a urethane material was used as an adhesive. An ethylene-propylene copolymer was used as a material of the support film on which an adhesive layer was arranged.

In Example 1, a modified polypropylene polymer that is an olefin material was used as an adhesive and mixed with modified isocyanate as an additive. A modified polyolefin agent was applied as an anchoring agent between the support film and the adhesive layer. Polyethylene terephthalate was used as a material of the support film on which the adhesive layer was arranged. Addition of the anchoring agent improved adhesion.

In Example 2, a modified polypropylene polymer that is a heat resistance-improving olefin material was used as an adhesive and mixed with modified isocyanate as an additive. Polyethylene terephthalate was used as a material of the support film on which the adhesive layer was arranged.

A contact angle of water on the surface of the adhesive layer was measured to determine the polarity of the surface of the adhesive layer (contact angle of water) using an automatic contact angle meter CA-Z (Kyowa Interface Science Co., LTD.) by a drop method according to JIS-K-2396. The measurement was performed at a measurement temperature of 25±2° C. and an amount of distilled water dropped of 4 μl. Tables 3 and 4 show the results. The measurement was performed twice in Comparative Examples 1 to 6 and Examples 1 and 2.

TABLE 3

| | Contact angle (°) | | | |
|---|---|---|---|---|
| | n = 1 | n = 2 | n = 3 | Average (°) |
| Comparative | 75.6 | 72.6 | 78.1 | 75.4 |
| Example 1 | | | | |
| Comparative | 81.0 | 83.5 | 83.3 | 82.6 |
| Example 2 | | | | |
| Comparative | 82.5 | 83.5 | 80.6 | 82.2 |
| Example 3 | | | | |
| Comparative | 86.8 | 87.5 | 90.3 | 88.2 |
| Example 4 | | | | |
| Comparative | 89.2 | 89.3 | 87.6 | 88.7 |
| Example 5 | | | | |
| Comparative | 88.4 | 90.3 | 88.4 | 89.0 |
| Example 6 | | | | |
| Example 1 | 94.0 | 97.4 | 97.5 | 96.3 |
| Example 2 | 93.0 | 94.8 | 95.7 | 94.5 |

TABLE 4

| | Contact angle (°) | | | |
|---|---|---|---|---|
| | n = 1 | n = 2 | n = 3 | Average (°) |
| Comparative | 72.9 | 73.8 | 76.3 | 74.3 |
| Example 1 | | | | |
| Comparative | 80.7 | 82.9 | 84.5 | 82.7 |
| Example 2 | | | | |
| Comparative | 81.0 | 80.5 | 82.7 | 81.4 |
| Example 3 | | | | |
| Comparative | 87.8 | 86.8 | 84.9 | 86.5 |
| Example 4 | | | | |
| Comparative | 88.3 | 87.0 | 85.2 | 86.8 |
| Example 5 | | | | |
| Comparative | 85.6 | 87.1 | 86.5 | 86.4 |
| Example 6 | | | | |
| Comparative | 71.5 | 71.8 | 70.1 | 71.1 |
| Example 7 | | | | |
| Example 1 | 106.2 | 99.2 | 96.6 | 100.6 |
| Example 2 | 96.9 | 95.7 | 97.4 | 96.6 |

As shown in Tables 3 and 4, the contact angles differ depending on the type of the adhesive. The contact angles in Examples 1 and 2 (olefin compounds) were 90° or larger and the contact angles in Comparative Examples 1 to 7 (acrylic compound or rubber compounds) were smaller than 90°.

Five types of molded resins (molded resins 1 to 5) were prepared and the surface polarity (contact angle of water) of the moth-eye film as an adherend was determined by the same method defined as above. Table 5 shows the results.

TABLE 5

| | Molded | Molded | Molded | Molded | |
|---|---|---|---|---|---|
| | resin 1 | resin 2 | resin 3 | resin 4 | Molded resin 5 |
| Contact angle (°) | 8.5 | 19.7 | 34.6 | 51.9 | 102.8 |

### Evaluation Test 1

Each of the protective films of Comparative Examples 1 to 7 and Examples 1 and 2 was stuck on the surface of a moth-eye film for 30 minutes. Then, the adhesion strength was examined. Table 6 shows the measurement results. Molded resins 1 to 5 having different contact angles were used as materials of the moth-eye films as adherends. Table 6 also shows a contact angle on the surface of the adhesive layer and a contact angle on the surface of the adherend.

TABLE 6

| | | Molded | Molded | Molded | Molded | Molded |
|---|---|---|---|---|---|---|
| | | resin 1 | resin 2 | resin 3 | resin 4 | resin 5 |
| | | Contact angle (°) | | | | |
| | | 8.5 | 19.7 | 34.6 | 51.9 | 102.8 |
| Comparative | 74.9 | Excellent | Excellent | Excellent | Excellent | Excellent |
| Example 1 | | | | | | |
| Comparative | 82.7 | Excellent | Excellent | Excellent | Excellent | Excellent |
| Example 2 | | | | | | |
| Comparative | 81.8 | Poor | Poor | Poor | Poor | Poor |
| Example 3 | | | | | | |
| Comparative | 87.4 | Poor | Poor | Fair | Poor | Fair |
| Example 4 | | | | | | |
| Comparative | 87.8 | Fair | Fair | Fair | Fair | Fair |
| Example 5 | | | | | | |
| Comparative | 87.7 | Fair | Excellent | Excellent | Excellent | Fair |
| Example 6 | | | | | | |
| Comparative | 71.1 | Not good | Not good | Not good | Not good | Not good |
| Example 7 | | | | | | |
| Example 1 | 98.5 | Excellent | Excellent | Excellent | Excellent | Excellent |
| Example 2 | 95.5 | Excellent | Excellent | Excellent | Excellent | Excellent |

Adhesion strength was evaluated based on peel force by the method in accordance with JIS-Z-0237. In Table 6, the peel force of 0.03 N/25 mm or less was too small and evaluated as “poor”, the peel force of 0.03 N/25 mm or more and 0.05 N/25 mm or less was slightly small and evaluated as “fair”, the peel force of 0.05 N/25 mm or more and 1.0 N/25 mm or less was evaluated as “excellent”, and the peel force of 1.0 N/25 mm or more was too large and evaluated as “not good”.

As shown in Table 6, the protective films of Comparative Examples 1 and 2 and Examples 1 and 2 could be each stuck on every adherend with good adhesion strength. On the other hand, the protective films of Comparative Examples 3 to 5 could not be stuck on any molded resin with sufficient adhesion strength and the protective films were easily removed from the moth-eye films. The protective film of Comparative Example 6 could not be stuck on some of the molded resins with sufficient adhesion strength. The protective film of Comparative Example 7 stuck on the adherend was too sticky to be removed, resulting in unfavorable adhesion. Such adhesion is not favorable. The results show that the adhesion between the protective film and the moth-eye film depends on an affinity between the adhesive and the material of the moth-eye film. If the surface of the adhesive layer includes an olefin compound so that the contact angle on the surface of the adhesive layer is 90° or larger, the adhesive layer is stuck on every molded resin with good adhesion strength regardless of their contact angles.

Each of the protective films of Comparative Examples 1 to 7 and Examples 1 and 2 was stuck on the moth-eye film for 30 minutes and the protective film was removed from the moth-eye film. The reflectance of the surface of the moth-eye film was examined. Table 7 shows the results. Adherends (molded resins 1 to 5) having different contact angles on the surfaces of these were used as the moth-eye film. Molded resins 1 to 5 having different contact angles were used as materials of the moth-eye films as adherends. Table 7 also shows the contact angle on the surface of the adhesive layer and the contact angle on the surface of the adherend.

The reflectance was measured using a spectrophotometer CM-2600d (Konica Minolta Holdings, Inc.) under the conditions of d/8 (diffuse illumination, 8° viewing), reflectance (Y value) in SCI (specular component included), measurement diameter φ8 mm, and 10° viewing field (D65).

TABLE 7

| | | Molded | Molded | Molded | Molded | Molded |
|---|---|---|---|---|---|---|
| | | resin 1 | resin 2 | resin 3 | resin 4 | resin 5 |
| | | Contact angle (°) | | | | |
| | | 8.5 | 19.7 | 34.6 | 51.9 | 102.8 |
| Comparative | 74.9 | 1.39 | 0.82 | 0.85 | 0.89 | 0.79 |
| Example 1 | | | | | | |
| Comparative | 82.7 | 0.38 | 0.23 | 0.23 | 0.22 | 0.22 |
| Example 2 | | | | | | |
| Comparative | 81.8 | 0.24 | 0.23 | 0.25 | 0.22 | 0.21 |
| Example 3 | | | | | | |
| Comparative | 87.4 | 0.19 | 0.24 | 0.22 | 0.21 | 0.20 |
| Example 4 | | | | | | |
| Comparative | 87.8 | 0.66 | 0.24 | 0.22 | 0.21 | 0.21 |
| Example 5 | | | | | | |
| Comparative | 87.7 | 0.92 | 0.34 | 0.35 | 0.34 | 0.32 |
| Example 6 | | | | | | |
| Comparative | 71.1 | 4.00 | 3.99 | 4.00 | 4.00 | 4.01 |
| Example 7 | | | | | | |
| Example 1 | 98.5 | 0.20 | 0.22 | 0.21 | 0.21 | 0.20 |
| Example 2 | 95.5 | 0.21 | 0.23 | 0.23 | 0.21 | 0.20 |
| Initial | — | 0.20 | 0.22 | 0.22 | 0.21 | 0.20 |
| character- | | | | | | |
| istics of | | | | | | |
| adherend | | | | | | |

Table 8 shows the results obtained by subtracting the reflectances of the surfaces of the adherends from the measurement results of entire reflectances shown in Table 7. This shows the difference between reflectances before and after the protective film was stuck on the moth-eye film.

TABLE 8

| | | Molded | Molded | Molded | Molded | Molded |
|---|---|---|---|---|---|---|
| | | resin 1 | resin 2 | resin 3 | resin 4 | resin 5 |
| | | Contact angle (°) | | | | |
| | | 8.5 | 19.7 | 34.6 | 51.9 | 102.8 |
| Comparative | 74.9 | 1.19 | 0.60 | 0.63 | 0.68 | 0.59 |
| Example 1 | | | | | | |
| Comparative | 82.7 | 0.18 | 0.01 | 0.01 | 0.01 | 0.02 |
| Example 2 | | | | | | |
| Comparative | 81.8 | 0.04 | 0.01 | 0.03 | 0.01 | 0.01 |
| Example 3 | | | | | | |
| Comparative | 87.4 | −0.01 | 0.02 | 0.00 | 0.00 | 0.00 |
| Example 4 | | | | | | |
| Comparative | 87.8 | 0.46 | 0.02 | 0.00 | 0.00 | 0.01 |
| Example 5 | | | | | | |
| Comparative | 87.7 | 0.72 | 0.12 | 0.13 | 0.13 | 0.12 |
| Example 6 | | | | | | |
| Comparative | 71.1 | 3.80 | 3.77 | 3.78 | 3.79 | 3.81 |
| Example 7 | | | | | | |
| Example 1 | 98.5 | 0.00 | 0.00 | −0.01 | 0.00 | 0.00 |
| Example 2 | 95.5 | 0.01 | 0.01 | 0.01 | 0.00 | 0.00 |

As shown in Table 8, in Comparative Examples 3 and 4 and Examples 1 and 2, little change in reflectance was observed in every molded resin. However, as shown in Table 6, the protective films of Comparative Examples 3 and 4 were insufficiently stuck on the moth-eye film. Therefore, no adhesive presumable flowed into gaps among protrusions of the moth-eye film to be left in the gaps.

On the other hand, the protective films of Comparative Examples 1, 2, 5 to 7 changed reflectance in at least some molded resins, which shows that a sufficient effect of reflectance reduction is not provided in some types of molded resins. In particular, the reflectance in the molded resin 1 having a low contact angle (10° or smaller) remarkably increased in use of the protective films of Comparative Examples 1, 2, 5 to 7.

The above-described results show that in order to effectively prevent an increase in reflectance due to a adhesive residue, an adhesive including an appropriate material and providing a sufficiently large contact angle is needed. The adhesives of Examples 1 and 2 can provide effects of excellent adhesion and prevention of contamination to every adherend.

The percentage (%) of contamination due to the adhesive is determined in accordance with the above-described results. The percentage of contamination is calculated by the formula: Percentage (%) of contamination=100×amount of contamination/amount of antireflection of adherend=100×amount of contamination/(reflectance of untreated surface−initial reflectance of adherend). FIG. 20 is a schematic view of an estimation of the percentage of contamination. The amount of contamination is calculated by the formula: amount of contamination=reflectance after removing protective film−initial reflectance of adherend. The term “reflectance of untreated surface” is referred to as reflectance of a flat surface that is subjected to no treatment of moth-eye protrusions and depressions. Table 9 shows the measurement results.

TABLE 9

| | | Molded | Molded | Molded | Molded | Molded |
|---|---|---|---|---|---|---|
| | | resin 1 | resin 2 | resin 3 | resin 4 | resin 5 |
| | | Contact angle (°) | | | | |
| | | 8.5 | 19.7 | 34.6 | 51.9 | 102.8 |
| Comparative | 74.9 | 31.1 | 15.7 | 16.4 | 17.8 | 15.4 |
| Example 1 | | | | | | |
| Comparative | 82.7 | 4.7 | 0.3 | 0.3 | 0.3 | 0.5 |
| Example 2 | | | | | | |
| Comparative | 81.8 | 1.0 | 0.3 | 0.8 | 0.3 | 0.3 |
| Example 3 | | | | | | |
| Comparative | 87.4 | −0.3 | 0.5 | 0.0 | 0.0 | 0.0 |
| Example 4 | | | | | | |
| Comparative | 87.8 | 12.0 | 0.5 | 0.0 | 0.0 | 0.3 |
| Example 5 | | | | | | |
| Comparative | 87.7 | 18.8 | 3.1 | 3.4 | 3.4 | 3.1 |
| Example 6 | | | | | | |
| Comparative | 71.1 | 99.2 | 98.4 | 98.7 | 99.0 | 99.5 |
| Example 7 | | | | | | |
| Example 1 | 98.5 | 0.0 | 0.0 | −0.3 | 0.0 | 0.0 |
| Example 2 | 95.5 | 0.3 | 0.3 | 0.3 | 0.0 | 0.0 |

As shown in Table 9, the protective films of Examples 1 and 2 did not contaminate all the molded resins and an adhesive was not left in the resins.

FIG. 21 shows the relations among a contact angle on the surface of an adhesive layer, an increment ΔY of reflectance (Y value), and the percentage (%) of the amount of contamination. FIG. 22 shows the relations among a contact angle on the surface of an adherend, an increment ΔY of reflectance (Y value), and the percentage (%) of the amount of contamination. FIG. 21 is a graph showing an increment ΔY of the reflectance (Y value) and the percentage (%) of the amount of contamination of the molded resins, wherein a contact angle on the surface of the adhesive layer is a variable (horizontal axis). FIG. 22 is a graph showing an increment ΔY of the reflectance (Y value) and the percentage (%) of the amount of contamination of the adhesives, wherein a contact angle on the surface of the adherend is a variable (horizontal axis).

As shown in FIG. 21, in all the molded resins, ΔY and the percentage (%) of the amount of contamination tend to decrease with an increase in contact angle on the surface of the adhesive layer. In the case that the contact angle on the surface of the adhesive layer was 80° or larger, the favorable results were obtained in which ΔY and the percentage (%) of contamination hardly increased. A molded resin with a small contact angle (molded resin 1 with a contact angle of smaller than 10°) tends to be more contaminated than the other molded resins (molded resins 2 to 5). In order to prevent contamination in the adherend of such a molded resin, an interaction with the surface of the adhesive layer needs to be reduced. Therefore, the contact angle on the surface of the adhesive layer needs to be set sufficiently high.

As shown in FIG. 22, the favorable results were obtained in which even if the adhesives of Examples 1 and 2 were used for any adherend, ΔY and the percentage (%) of the amount of contamination hardly increased. That is, in order to prevent contamination in an adherend that has a small contact angle while maintaining the adhesion, the contact angle on the surface of the adhesive layer needs to be increased to as large as the contact angles of Examples 1 and 2. In Comparative Example 7, the adherend is extremely contaminated and the depressions are almost clogged, which results in few antireflection effect.

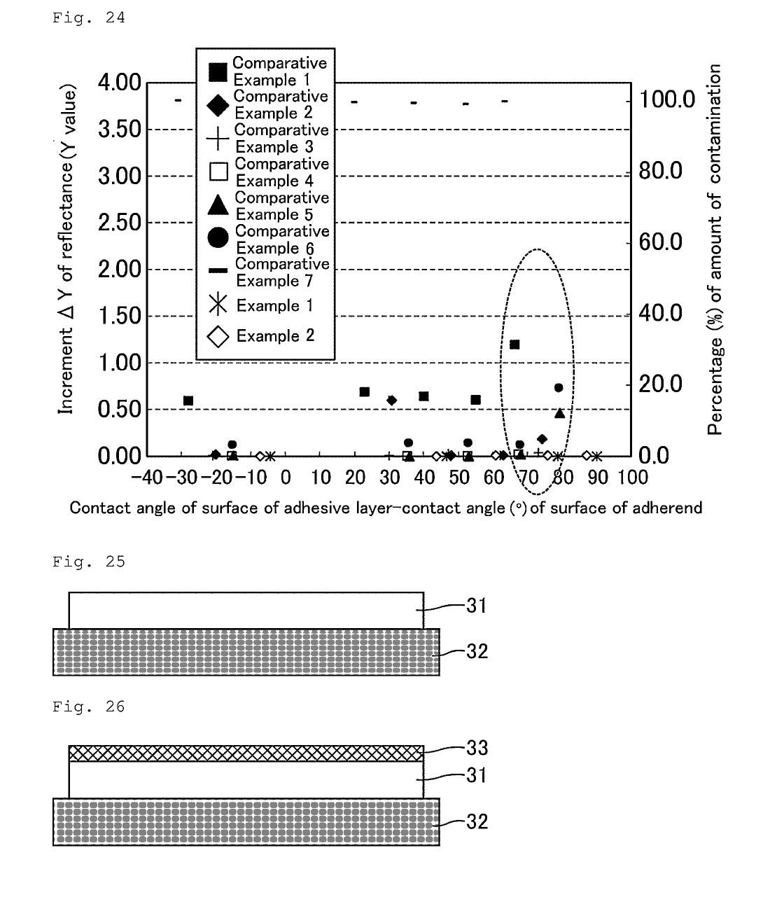

The difference between the contact angles (°) on the surface of the adherend and the surface of the adhesive layer is examined based on the above measurement results. Table 10 shows the examination results. FIGS. 23 and 24 each show the relations among the difference between the contact angles (°) on the surface of the adhesive layer and the adherend, the increment ΔY of reflectance (Y value), and the percentage (%) of the amount of contamination. FIG. 23 is a graph showing the increment ΔY of the reflectance (Y value) and the percentage (%) of the amount of contamination of each molded resin, wherein the difference between the contact angles (°) on the surface of the adhesive layer and the surface of the adherend is a variable (horizontal axis). FIG. 24 is a graph showing the increment ΔY of the reflectance (Y value) and the percentage (%) of the amount of contamination of each adhesive, wherein the difference between the contact angles (°) on the surface of the adhesive layer and the surface of the adherend is a variable (horizontal axis).

TABLE 10

| | | Molded | Molded | Molded | Molded | Molded |
|---|---|---|---|---|---|---|
| | | resin 1 | resin 2 | resin 3 | resin 4 | resin 5 |
| | | Contact angle (°) | | | | |
| | | 8.5 | 19.7 | 34.6 | 51.9 | 102.8 |
| Comparative | 74.9 | 66.4 | 55.2 | 40.3 | 23.0 | −27.9 |
| Example 1 | | | | | | |
| Comparative | 82.7 | 74.2 | 63.0 | 48.1 | 30.8 | −20.2 |
| Example 2 | | | | | | |
| Comparative | 81.8 | 73.3 | 62.1 | 47.2 | 29.9 | −21.0 |
| Example 3 | | | | | | |
| Comparative | 87.4 | 78.9 | 67.7 | 52.8 | 35.5 | −15.5 |
| Example 4 | | | | | | |
| Comparative | 87.8 | 79.3 | 68.1 | 53.2 | 35.9 | −15.0 |
| Example 5 | | | | | | |
| Comparative | 87.7 | 79.2 | 68.0 | 53.1 | 35.8 | −15.1 |
| Example 6 | | | | | | |
| Comparative | 71.1 | 62.6 | 51.4 | 36.5 | 19.2 | −31.7 |
| Example 7 | | | | | | |
| Example 1 | 98.5 | 90.0 | 78.8 | 63.9 | 46.6 | −4.3 |
| Example 2 | 95.5 | 87.0 | 75.8 | 60.9 | 43.6 | −7.3 |

As shown in Table 10 and FIG. 23, all the molded resins show that ΔY and the percentage (%) of the amount of contamination tend to increase as the difference between the contact angles on the surface of the adhesive layer and the surface of each molded resin decreases, that is, tend to increase as the value of the contact angle on the surface of the adhesive layer becomes closer to the value of the contact angle on the surface of the adherend. In other words, the contamination of each adherend decreases as the difference between the contact angles on the surface of the adhesive layer and the surface of the adherend increases.

As shown in Table 10 and FIG. 24, the favorable results were obtained in which regardless of the difference between the contact angles on the surface of the adhesive layer and the surface of the adherend, increases in ΔY and the percentage (%) of the amount of contamination were hardly observed in use of each of the adhesives of Examples 1 and 2 containing an olefin compound. Unlike the protective films of Comparative Examples 3 and 4 that are weakly stuck on an adherend, the protective film of Comparative Example 5 such that the difference between the contact angles on the protective film and the adherend becomes minus, the protective film of Comparative Example 7 entirely contaminating an adherend, and the protective films of Examples 1 and 2 having a sufficiently large contact angle, the amount of the adhesive left by the adhesive layers of Comparative Examples 1, 2, and 6 may increase from beyond about 70 degrees of the difference between the contact angles on the surface of the adhesive layer and the surface of the adherend (at a portion surrounded by a dotted line in FIG. 24). That is, the contamination is remarkably observed on the surface of an adherend having a small contact angle by the surfaces of the adhesive layers of Comparative Examples 1, 2, and 6.

The results are summarized below. The adherend (molded resin 1) with a contact angle of 10° or smaller is particularly likely to be contaminated compared to the other adherends (molded resins 2 to 5). In order to prevent the adherend from contamination, the contact angle on the surface of the adhesive layer needs to be increased. Therefore, the difference between the contact angles on the adherend and the adhesive layer needs to be increased. Favorable adhesion strength is obtained and contamination is reduced as the difference between the contact angles increases. Specifically, the difference between the contact angles is preferably 80° or larger and more preferably 90° or larger. The adhesives of Examples 1 and 2 containing an olefin compound provide good results regardless of the difference between the contact angles.

### Evaluation Test 2

Each of the protective films of Comparative Examples 1 to 7 and Examples 1 and 2 was stuck on the surface of each of five films including a TAC film (without antireflection coating), a clear LR film, an AGLR film, an AG film (without antireflection coating), and a moth-eye film, for 30 minutes and the adhesion and resistance to contamination were evaluated. The evaluations were performed using five types of adherends (Reference Examples 1 to 4 and Example 3) shown in Table 11.

TABLE 11

| | Reference | Reference | Reference | Reference | |
|---|---|---|---|---|---|
| | Example 1 | Example 2 | Example 3 | Example 4 | Example 3 |
| Surface | No treatment | Low | Low reflection | AG treatment | Moth-eye ultra |
| treatment | | reflection | AG treatment | | low reflection |
| | | treatment | | | treatment |
| Protrusions | None | None | Protrusions and | Protrusions and | Protrusions and |
| and | | | depressions of | depressions of | depressions of |
| depressions | | | μm order | μm order | nm order |
| Low | None | Thin film | Thin film using | None | Moth eye |
| reflection | (TAC) | using light | light | (AG only) | |
| treatment | | interference | interference | | |
| | | (clear LR) | (AGLR) | | |

FIGS. 25 to 29 are schematic cross-sectional views of adherends of Reference Example 1 to 4 and Example 3. As shown in FIGS. 25 to 29, the adherends each include a TAC film 31 as a base and a flat black acrylic board (SUMIPEX 960, Sumitomo Chemical Co., Ltd.) 32 that is stuck on the TAC film 31 using an adhesive having substantially the same refractive index as the black acrylic board. The refractive index of the black acrylic board for the sodium D lines of (589.3 nm) is 1.492.

FIG. 25 is a schematic cross-sectional view of an adherend of Reference Example 1. As shown in FIG. 25, the adherend of Reference Example 1 is an example of an adherend that is not subjected to any treatment such as low reflection treatment and has a configuration where only the TAC film 31 and the black acrylic board 32 are stacked on each other.

FIG. 26 is a schematic cross-sectional view of the adherend of Reference Example 2. As shown in FIG. 26, the adherend of Reference Example 2 is subjected to low reflection treatment and a clear LR coating 33 using light interference is applied on the TAC film 31. That is, the adherend has a configuration where the TAC film 31 having a surface that is subjected to clear LR treatment and the black acrylic board 32 are stacked on each other.

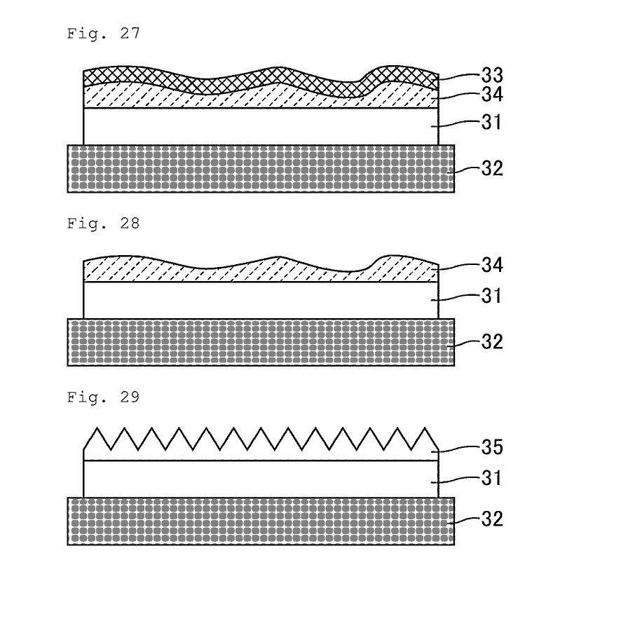

FIG. 27 is a schematic cross-sectional view of the adherend of Reference Example 3. As shown in FIG. 27, the adherend of Reference Example 3 is subjected to anti-glare (AG) treatment, followed by low reflection treatment, and has an AG coating 34 that is applied on the surface of the TAC film 31 and the clear LR coating 33 using light interference that is applied on the AG coating 34. That is, the adherend has a configuration where the AG treated TAC film 31 that is subjected to clear LR treatment and the black acrylic board 32 are stacked on each other.

FIG. 28 is a schematic cross-sectional view of the adherend of Reference Example 4. As shown in FIG. 28, the adherend of Reference Example 4 includes a TAC film 31 in which the surface is subjected to anti-glare (AG) treatment to form a coating 34 with micron-order protrusions and depressions. That is, the adherend has a configuration where the TAC film 31 having a surface that is subjected to AG treatment and the black acrylic board 32 are stacked on each other.

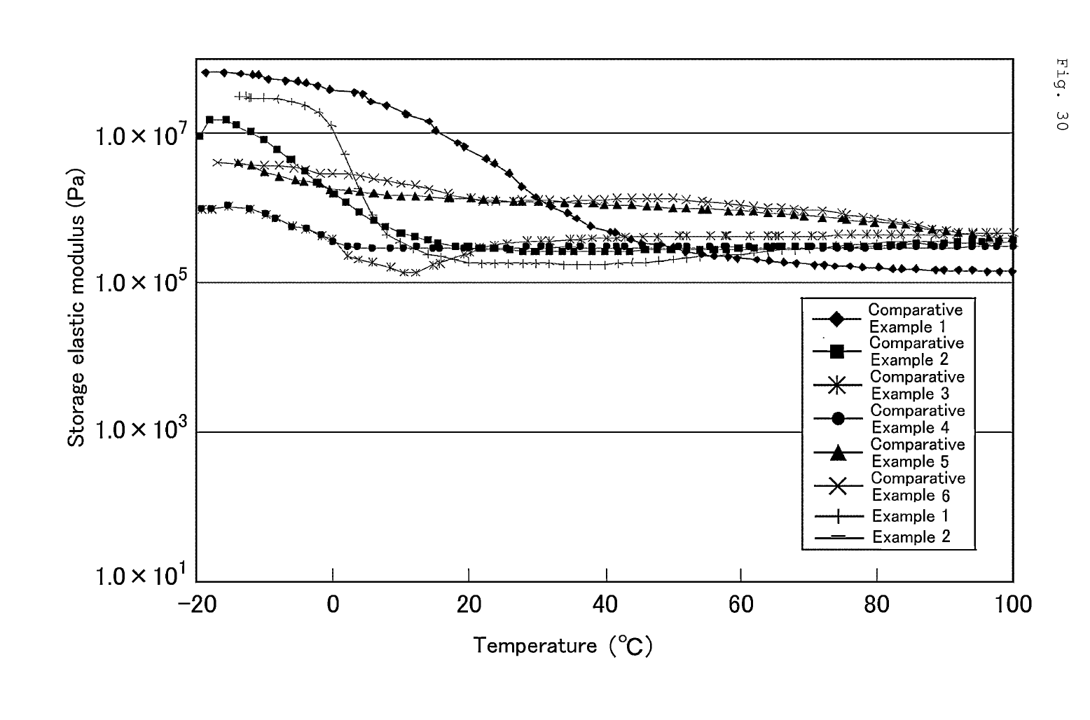

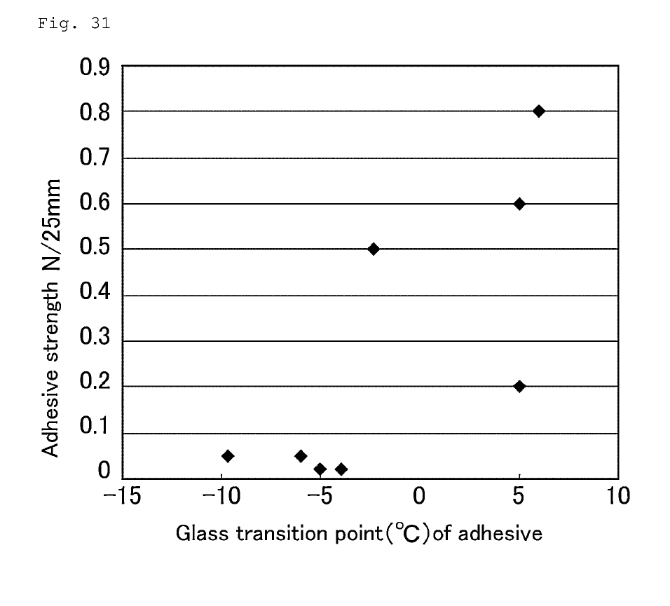

FIG. 29 is a schematic cross-sectional view of the adherend of Example 3. As shown in FIG. 29, the adherend of Example 3 includes the TAC film 31 and a moth-eye structure 35 that, is formed on the film 31 by moth-eye ultra-low reflection treatment. That is, the adherend has a configuration where the TAC film 31 having the moth-eye structure 35 on its surface and the black acrylic board 32 are stacked on each other.

In the evaluation test 2, first, each of the protective films of Comparative Examples 1 to 7 and Examples 1 and 2 was stuck on each of the adherends shown in Table 11 and FIGS. 25 to 29 (Reference Examples 1 to 4 and Example 3) for 30 minutes and the protective film was removed. The contamination due to an adhesive was evaluated. Table 12 shows the measurement results.

The reflectance was measured using a spectrophotometer CM-2600d (Konica Minolta Holdings, Inc.) under the conditions of d/8 (diffuse illumination, 8° viewing), reflectance Y value in SCI (specular component included), measurement diameter 08 mm, and 10° viewing field (D65).

TABLE 12

| | | | Reference | | Example 3 |
|---|---|---|---|---|---|
| | | Reference | Example 3 | | Moth-eye |
| | Reference | Example 2 | Low | Reference | ultra |
| | Example 1 | Low | reflection | Example 4 | low |
| | No | reflection | AG | AG | reflection |
| | treatment | treatment | treatment | treatment | treatment |
| Comparative | 4.03 | 1.50 | 1.94 | 4.71 | 1.39 |
| Example 1 | | | | | |
| Comparative | 4.02 | 1.50 | 1.94 | 4.70 | 0.38 |
| Example 2 | | | | | |
| Comparative | 4.02 | 1.50 | 1.93 | 4.71 | 0.66 |
| Example 3 | | | | | |
| Comparative | 4.02 | 1.50 | 1.93 | 4.71 | 0.92 |
| Example 4 | | | | | |
| Comparative | 4.03 | 1.49 | 1.94 | 4.70 | 0.24 |
| Example 5 | | | | | |
| Comparative | 4.02 | 1.50 | 1.94 | 4.71 | 0.19 |
| Example 6 | | | | | |
| Comparative | 4.02 | 1.49 | 1.93 | 4.71 | 4.00 |
| Example 7 | | | | | |
| Example 1 | 4.02 | 1.50 | 1.93 | 4.71 | 0.21 |
| Example 2 | 4.02 | 1.50 | 1.93 | 4.71 | 0.20 |
| Initial value | 4.03 | 1.50 | 1.94 | 4.71 | 0.20 |
| of adherend | | | | | |

Table 13 shows the results obtained by subtracting the reflectances of the surfaces of the adherends from the measurement results of entire reflectances. This shows the difference between reflectances before and after the protective film is stuck on the adherend.

TABLE 13

| | | | Reference | | Example 3 |
|---|---|---|---|---|---|
| | | Reference | Example 3 | | Moth-eye |
| | Reference | Example 2 | Low | Reference | ultra |
| | Example 1 | Low | reflection | Example 4 | low |
| | No | reflection | AG | AG | reflection |
| | treatment | treatment | treatment | treatment | treatment |
| Comparative | 0.00 | 0.00 | 0.00 | 0.00 | 1.19 |
| Example 1 | | | | | |
| Comparative | −0.01 | 0.00 | 0.00 | −0.01 | 0.18 |
| Example 2 | | | | | |
| Comparative | −0.01 | 0.00 | −0.01 | 0.00 | 0.46 |
| Example 3 | | | | | |
| Comparative | −0.01 | 0.00 | −0.01 | 0.00 | 0.72 |
| Example 4 | | | | | |
| Comparative | 0.00 | −0.01 | 0.00 | −0.01 | 0.04 |
| Example 5 | | | | | |
| Comparative | −0.01 | 0.00 | 0.00 | 0.00 | −0.01 |
| Example 6 | | | | | |
| Comparative | −0.01 | −0.01 | −0.01 | 0.00 | 3.80 |
| Example 7 | | | | | |
| Example 1 | −0.01 | 0.00 | −0.01 | 0.00 | 0.01 |
| Example 2 | −0.01 | 0.00 | −0.01 | 0.00 | 0.00 |

As shown in Tables 12 and 13, the reflectances of the films other than the moth-eye film are remarkably changed depending on the type of the adhesive. On the other hand, the reflectance of the moth-eye film is not remarkably changed. This means that conventional adhesives are not designed to be used for the moth-eye film and such adhesives may deteriorate antireflection characteristics of the moth-eye film.

Next, each of the protective films of Comparative Examples 1 to 7 and Examples 1 and 2 was stuck on each of the adherends (Reference Examples 1 to 4 and Example 3) for a predetermined time and the adhesion strength was examined when the protective film is removed. Table 14 shows the results.

TABLE 14

| | | | Reference | | Example 3 |
|---|---|---|---|---|---|
| | | Reference | Example 3 | | Moth-eye |
| | Reference | Example 2 | Low | Reference | ultra |
| | Example 1 | Low | reflection | Example 4 | low |
| | No | reflection | AG | AG | reflection |
| | treatment | treatment | treatment | treatment | treatment |
| Comparative | Excellent | Poor | — | — | Excellent |
| Example 1 | | | | | |
| Comparative | Excellent | Excellent | Fair | Fair | Excellent |
| Example 2 | | | | | |
| Comparative | Excellent | Fair | Poor | Poor | Poor |
| Example 3 | | | | | |
| Comparative | Excellent | Poor | Poor | Poor | Poor |
| Example 4 | | | | | |
| Comparative | Excellent | Excellent | — | Poor | Fair |
| Example 5 | | | | | |
| Comparative | Excellent | Excellent | Fair | Fair | Fair |
| Example 6 | | | | | |
| Comparative | Excellent | Excellent | Excellent | Excellent | Heavy |
| Example 7 | | | | | |
| Example 1 | Excellent | Excellent | Poor | Poor | Excellent |
| Example 2 | Excellent | Excellent | — | Poor | Excellent |

The adhesion strength is evaluated by performing removal strength evaluation test by hand. The case that the protective film is not stuck is represented by “-”, the case that removal strength is low (the protective film is too easily removed) is represented by “poor”, the case that the peel force is slightly small (the protective film is slightly too easily peeled) is represented by “fair”, the case that the protective film is favorably peeled is represented by “excellent”, the case that the peel force is large (the protective film is less likely to be peeled) is represented by “heavy”.

As shown in Table 14, all the protective films of Comparative Examples 1 to 7 and Examples 1 and 2 can be stuck on the TAC film with good adhesion, but they are stuck to the other films with different levels of adhesion.

Among these, the protective films of Comparative Examples 1 and 2 and Examples 1 and 2 showing good adhesion to the moth-eye film are stuck on the almost flat TAC film or the clear LR film with good adhesion, but not stuck on the AG film with good adhesion. This means that protrusions and depressions with a micron-sized pitch and protrusions and depressions with a nano-sized pitch provide different results.

The comprehensive evaluation of adhesion and resistance to contamination based on the examination results are summarized in Table 15.

TABLE 15

| | | | Reference | | Example 3 |
|---|---|---|---|---|---|
| | | Reference | Example 3 | | Moth-eye |
| | Reference | Example 2 | Low | Reference | ultra |
| | Example 1 | Low | reflection | Example 4 | low |
| | No | reflection | AG | AG | reflection |
| | treatment | treatment | treatment | treatment | treatment |
| Comparative | Good | Fair | — | — | Poor |
| Example 1 | | | | | |
| Comparative | Good | Good | Fair | Fair | Poor |
| Example 2 | | | | | |
| Comparative | Good | Fair | Fair | Fair | Poor |
| Example 3 | | | | | |
| Comparative | Good | Fair | Fair | Fair | Poor |
| Example 4 | | | | | |
| Comparative | Good | Good | — | Fair | Poor |
| Example 5 | | | | | |
| Comparative | Good | Good | Fair | Fair | Fair |
| Example 6 | | | | | |
| Comparative | Good | Good | Good | Good | Poor |
| Example 7 | | | | | |
| Example 1 | Good | Good | Fair | Good | Good |
| Example 2 | Good | Good | — | Good | Good |

In the comprehensive evaluation, the result of good adhesion and no contamination is represented by “good”, the result of low adhesion and no contamination is represented by “fair”, the result of contamination is represented by “poor”, the result of no adhesion is represented by “-” (unevaluable). The evaluation result of “good adhesion” is the same as the evaluation result represented by “excellent or heavy” in Table 14. The evaluation result of “low adhesion” is the same as the evaluation result represented by “fair or poor” in Table 14.

Table 15 shows that the protective films in Comparative Examples 1 to 7 can be stuck on the films other than the moth-eye film with a certain level of good adhesion and a certain level of good resistance to contamination. However, such results indicate that the protective films are not suitable for the moth-eye film. On the other hand, the protective films in Examples 1 and 2 are stuck on the moth-eye film with good adhesion and without contamination due to an adhesive.

### Evaluation Test 3

The protective films in Comparative Examples 1 to 6 and Examples 1 and 2 are examined for the relation between molecular weight distribution and adhesion and the relation between molecular weight distribution and resistance to contamination. Table 16 shows the results.

The molecular weight distribution was measured using HLC-8220 (Shimadzu Corp.) by a GPC (Gel permeation chromatography) method under the conditions of a flow rate of 1.0 ml/min, a detecting method of RI, a concentration of 0.1%, an injection volume of 50 μl, a pressure of 5.0 MPa, a column temperature of 40° C., a system temperature of 40° C., and an eluent of THF. Each of the variances in Table 16 shows polymer distribution and is determined by Mw/Mn (weight average molecular weight/number average molecular weight).

TABLE 16

| | | | | | | | Proportion of low |
|---|---|---|---|---|---|---|---|
| | | | Peak on high- | | Peak on low- | | molecular component |
| | | | molecular side | | molecular side | | based on entire |
| | Remaining | Adhesion | Molecular | | Molecular | | components |
| | adhesive | strength | weight Mw | Variance | weight Mw | Variance | (solvent excluded) |
| Comparative | ** | Excellent | 3.9 × 10⁵ | 8.9 | 835 | 1.2 | 0.019 |
| Example 1 | | | | | | | |
| Comparative | Fair | Excellent | 3.3 × 10⁵ | 4.9 | 1000 | 1.1 | 0.028 |
| Example 2 | | | | | | | |
| Comparative | Fair | * | 6.3 × 10⁵ | 13.7 | 880 | 1.1 | 0.042 |
| Example 3 | | | | | | | |
| Comparative | ** | * | 5.9 × 10⁵ | 5.7 | 1100 | 1.1 | 0.004 |
| Example 4 | | | | | | | |
| Comparative | ** | Fair | 0.9 × 10⁵ | 1.2 | 1460 | 1.5 | 0.350 |
| Example 5 | | | | | | | |
| Comparative | Good | Fair | 1.0 × 10⁵ | 1.3 | 1350 | 1.4 | 0.340 |
| Example 6 | | | | | | | |
| Example 1 | Good | Excellent | 4.4 × 10⁵ | 2.2 | 1050 | 1.3 | 0.006 |
| Example 2 | Good | Excellent | 3.2 × 10⁵ | 4.1 | 750 | 1.1 | 0.032 |

Table 16 shows that no peak is preferably present on the low-molecular side, that is, low molecular component contents are preferably low, in view of adhesion strength. Specifically, the proportion of low molecular components is preferably 0.05 or less based on the entire components. The “proportion of low molecular components” means the proportion of an integral value of low molecules measured using GPC and is represented by an area ratio of low molecules in the total area. A low molecule component (low-molecular-weight substance) refers to a monomer or an oligomer but not refers to a polymer. The first peak on the high molecular side in the molecular weight distribution represents high molecular components (high molecular weight substance) and the other components are low molecular components (low molecular weight substance).

### Evaluation Test 4

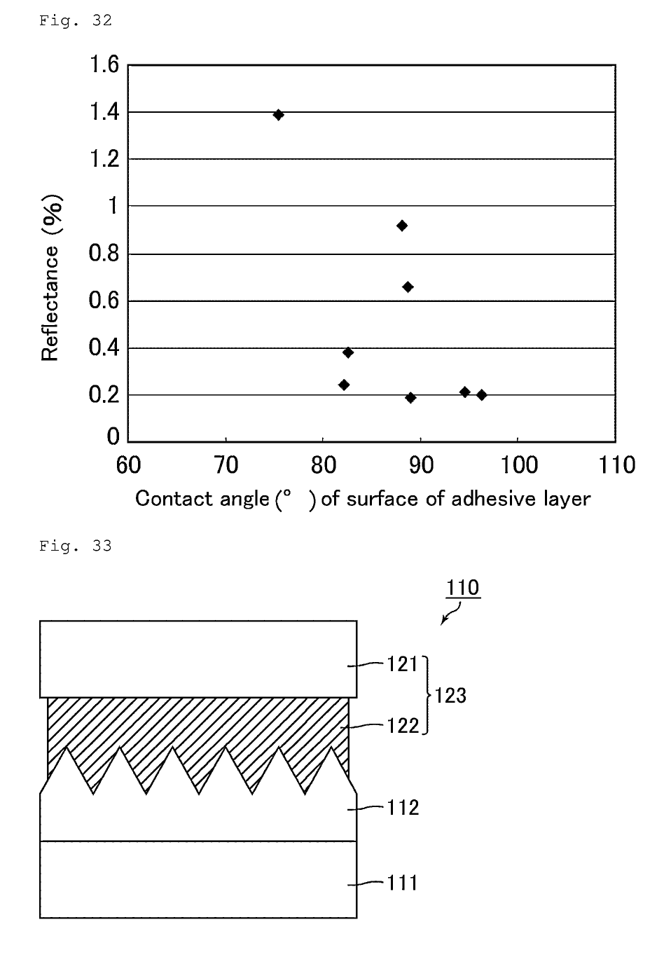

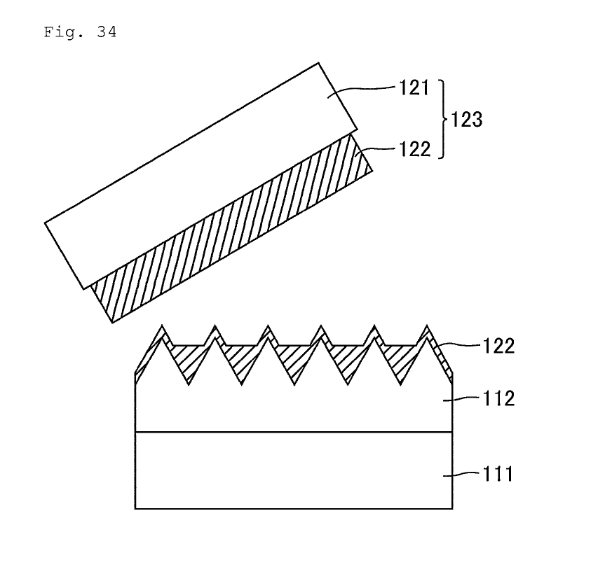

The protective films of Comparative Examples 1 to 6 and Examples 1 and 2 are examined for the relation among storage elastic modulus, a glass transition point, adhesion, and resistance to contamination. FIGS. 30 and 31 and Table 17 show the results. FIG. 30 is a graph showing temperature dependency of storage elastic moduli (Pa) of adhesives in Comparative Examples 1 to 6 and Examples 1 and 2. FIG. 31 is a graph showing the relation between the glass transition point (° C.) and the adhesion strength N/25 mm of adhesives in Comparative Examples 1 to 6 and Examples 1 and 2.

The storage elastic modulus and the glass transition point were measured using a liquid phase viscoelasticity measuring apparatus MR-500 (UBM CO., LTD.) under the conditions of frequency of 1 Hz, distortion of 0.2 deg, a temperature increase rate of 3° C./min, a starting temperature of −20° C., and a final temperature of 100° C.

TABLE 17

| | | | | | | | Glass |
|---|---|---|---|---|---|---|---|
| | Remaining | Adhesion | Storage elastic modulus (MPa) | | | | transition |
| | adhesive | strength | 0° C. | 23° C. | 50° C. | 100° C. | point (° C.) |
| Comparative | ** | Excellent | 38 | 4.4 | 0.29 | 0.14 | −2.3 |
| Example 1 | | | | | | | |
| Comparative | Fair | Excellent | 1.5 | 2.8 | 0.27 | 0.36 | 5 |
| Example 2 | | | | | | | |
| Comparative | Fair | * | 0.39 | 0.31 | 0.41 | 0.46 | −5 |
| Example 3 | | | | | | | |
| Comparative | ** | * | 3.5 | 0.28 | 0.3 | 0.31 | −4 |
| Example 4 | | | | | | | |
| Comparative | ** | Fair | 1.7 | 1.3 | 1 | 0.38 | −9.7 |
| Example 5 | | | | | | | |
| Comparative | Good | Fair | 2.8 | 1.2 | 1.3 | 0.39 | −6 |
| Example 6 | | | | | | | |
| Example 1 | Good | Excellent | 12 | 0.18 | 0.2 | 0.3 | 5 |
| Example 2 | Good | Excellent | 3.2 | 0.1 | 0.2 | 0.39 | 6 |

Table 17 shows that a higher glass transition point is preferred in view of adhesion strength. Specifically, the glass transition point of the adhesive is preferably −5° C. or higher. Further, Table 17 shows that the storage elastic modulus is preferably low at an ordinary temperature (23° C.) in view of the adhesion strength and preventing an adhesive residue. Specifically, the storage elastic modulus of the adhesive at an ordinary temperature (23° C.) is preferably 0.05 MPa or higher and 0.20 MPa or lower.

### Evaluation Test 5

FIG. 32 and Tables 18 and 19 show the relation between adhesion to an adherend and the contact angles on the surface of the adhesive layers, and the relation between resistance to contamination of an adherend and the contact angles on the surface of the adhesive layers, in the protective films of Comparative Examples 1 to 6 and Examples 1 and 2. FIG. 32 is a graph showing the relation between the contact angle (°) on the surface of the adhesive layer and the reflectance (%) in Comparative Examples 1 to 6 and Examples 1 and 2.

TABLE 18

| | Remaining | Adhesion | Contact angle (°) | | | |
|---|---|---|---|---|---|---|
| | adhesive | strength | n = 1 | n = 2 | n = 3 | Average (°) |
| Comparative | ** | Excellent | 75.6 | 72.6 | 78.1 | 75.4 |
| Example 1 | | | | | | |
| Comparative | Fair | Excellent | 81.0 | 83.5 | 83.3 | 82.6 |
| Example 2 | | | | | | |
| Comparative | Fair | * | 82.5 | 83.5 | 80.6 | 82.2 |
| Example 3 | | | | | | |
| Comparative | ** | * | 86.8 | 87.5 | 90.3 | 88.2 |
| Example 4 | | | | | | |
| Comparative | ** | Fair | 89.2 | 89.3 | 87.6 | 88.7 |
| Example 5 | | | | | | |
| Comparative | Good | Fair | 88.4 | 90.3 | 88.4 | 89.0 |
| Example 6 | | | | | | |
| Example 1 | Good | Excellent | 94.0 | 97.4 | 97.5 | 96.3 |
| Example 2 | Good | Excellent | 93.0 | 94.8 | 95.7 | 94.5 |

TABLE 19

| | Remaining | Adhesion | Contact angle (°) | | | |
|---|---|---|---|---|---|---|
| | adhesive | strength | n = 1 | n = 2 | n = 3 | Average (°) |
| Comparative | ** | Excellent | 72.9 | 73.8 | 76.3 | 74.3 |
| Example 1 | | | | | | |
| Comparative | Fair | Excellent | 80.7 | 82.9 | 84.5 | 82.7 |
| Example 2 | | | | | | |
| Comparative | Fair | Poor | 81.0 | 80.5 | 82.7 | 81.4 |
| Example 3 | | | | | | |
| Comparative | ** | Poor | 87.8 | 86.8 | 84.9 | 86.5 |
| Example 4 | | | | | | |
| Comparative | ** | Fair | 88.3 | 87.0 | 85.2 | 86.8 |
| Example 5 | | | | | | |
| Comparative | Good | Fair | 85.6 | 87.1 | 86.5 | 86.4 |
| Example 6 | | | | | | |
| Comparative | Poor | Heavy | 71.5 | 71.8 | 70.1 | 71.1 |
| Example 7 | | | | | | |
| Example 1 | Good | Excellent | 106.2 | 99.2 | 96.6 | 100.6 |
| Example 2 | Good | Excellent | 96.9 | 95.7 | 97.4 | 96.6 |

FIG. 32 and Tables 18 and 19 show that the contact angle on the surface of the adhesive layer of Example 1 is 96.3° to 100.6° and the contact angle on the surface of the adhesive layer of Example 2 is 94.5° to 96.6°.

Further, FIG. 32 and Tables 18 and 19 show that the contact angle is preferably large in view of improving adhesion strength and preventing an adhesive residue at the same time. Specifically, the contact angle on the adhesive layer is preferably 90° or larger.

The adhesive layer in Comparative Example 6 that is embossed is preferable in view of preventing an adhesive residue, but needs to be improved in view of adhesion strength.

The present application claims priority to Patent Application No. 2010-068762 filed in Japan on Mar. 24, 2010 under the Paris Convention and provisions of national law in a designated State, the entire contents of which are hereby incorporated by reference.

### REFERENCE SIGNS LIST

10, 110: Laminate (optical member)
11, 111: Base
12, 112: Moth-eye film (anti-reflection film)
12a: Protrusion
12b: Base portion
12c: Col
12x: Residual-resin film layer
12y: Film base
12z: Adhesion layer
13, 113: Protective film
21, 121: Support film
22, 122: Adhesive layer
31: TAC film
32: Black acrylic board
33: Clear LR coating
34: AG coating
34: Moth-eye structure

1. A laminate comprising:
an anti-reflection film; and
a protective film stuck on the anti-reflection film,
wherein the surface of the anti-reflection film has multiple protrusions, the distance between two tips of adjacent protrusions being equal to or smaller than visible light wavelength, and
the protective film includes a support film and an adhesive layer that is in contact with the anti-reflection film, the adhesive layer including an adhesive that contains a polymer having an olefin structure as a monomer unit.

2. The laminate according to claim 1,
wherein a contact angle of water on the surface of the anti-reflection film is 10° or smaller.

3. The laminate according to claim 1 or 2,
wherein a contact angle of water on the surface of the adhesive layer is 90° or larger.

4. The laminate according to claim 1,
wherein a difference between a contact angle of water on the surface of the adhesive layer and a contact angle of water on the surface of the anti-reflection film is 80° or larger.

5. The laminate according to claim 1,
wherein the proportion of a low molecular component in the adhesive is 0.05 or less.

6. The laminate according to claim 1,
wherein storage elastic modulus of the adhesive at an ordinary temperature of 23° C. is 0.05 MPa or more and 0.20 MPa or less.

7. The laminate according to claim 1,
wherein a glass transition temperature of the adhesive is −5° C. or higher.
